(19) United States
(12) Patent Application Publication
(10) Pub. No.: US 2022/0011887 A1
(43) Pub. Date: Jan. 13, 2022

(54) ELECTRONIC DEVICE FOR EXECUTING OPERATION BASED ON USER INPUT VIA ELECTRONIC PEN, AND OPERATING METHOD THEREOF

(71) Applicant: SAMSUNG ELECTRONICS CO., LTD., Suwon-si (KR)

(72) Inventors: Md Mahmud Muntakim KHAN, Dhaka (IN); Faisal KHAN, Dhaka (IN); M Shaykat SHUVA, Dhaka (IN)

(21) Appl. No.: 17/485,938

(22) Filed: Sep. 27, 2021

Related U.S. Application Data
(63) Continuation of application No. PCT/KR2019/016901, filed on Dec. 3, 2019.

(30) Foreign Application Priority Data
Mar. 28, 2019 (KR) 10-2019-0036205

(51) Int. Cl. G06F 3/0354; G06F 3/041; G06F 3/0488

(52) U.S. Cl. CPC G06F 3/03545; G06F 3/04883; G06F 3/04162

(57) ABSTRACT

Provided are an electronic device for executing an operation based on a user input via an electronic pen and an operating method of the electronic device, the operating method including: connecting to the electronic pen; receiving, from the electronic pen, a first input via a touch input to a touch pad at least one operation of rotation of at least a part of the electronic pen or the entire electronic pen; and executing a preset operation based on the first input.

### CROSS-REFERENCE TO RELATED APPLICATIONS

This application is a continuation of International Application No. PCT/KR2019/016901 designating the United States, filed on Dec. 3, 2019 in the Korean Intellectual Property Receiving Office and claiming priority to Korean Patent Application No. 10-2019-0036205, filed on Mar. 28, 2019, in the Korean Intellectual Property Office, the disclosures of which are incorporated by reference herein in their entireties.

### BACKGROUND

### Field

The disclosure relates to an electronic device executing an operation based on a user input via an electronic pen, and an operating method of the electronic device.

### Description of Related Art

Recently, an electronic device has been configured to perform various functions. Examples of the various functions include a data and voice communication function, a function of capturing an image or recording a video using a camera, a voice recording function, a function of playing a music file using a speaker system, and a function of displaying an image or a video. To perform these functions, various applications have been developed and used along with the development of electronic devices.

According to the related art, a device used by a user to input required information such as control information or data to an electronic device is limited to a keypad, a physical button, or the like. Through the progress in electronic devices, users are now able to conveniently input required information to an electronic device using a touch screen panel (TSP).

Recently, in line with the progress in electronic devices, functions provided by an electronic device are diversifying, and an electronic device may be manipulated by a user under various circumstances. Thus, there is a need for user input devices that are more convenient and sophisticated. Accordingly, electronic devices including an electronic pen as an input device are on the increase.

Furthermore, to provide various functions, electronic pens have also developed from passive pens that simply provide a touch input to active pens which have their own functions.

### SUMMARY

Embodiments of the disclosure provide an electronic device for executing an operation based on a user input via an electronic pen, and an operating method of the electronic device.

According to an example embodiment of the disclosure, a method of operating an electronic device that executes an operation based on a user input via a touch input to a touch pad or an electronic pen includes: connecting to the electronic pen; receiving, from the electronic pen, a first input via at least one operation of rotation of at least a part of the electronic pen or the entire electronic pen; and executing a preset operation based on the first input.

The executing of a preset operation may include changing a viewpoint of a user on a screen displayed to the user according to a touch input direction with respect to the touch pad or a rotational direction of the rotation of the at least a part of the electronic pen or the entire electronic pen.

The executing of a preset operation may include changing at least a portion of a screen displayed to a user or the entire screen according to a touch input direction with respect to the touch pad or a rotational direction of the rotation of the at least a part of the electronic pen or the entire electronic pen.

The executing of a preset operation may include increasing or reducing a preset value according to a touch input direction with respect to the touch pad or a rotational direction of the rotation of the at least a part of the electronic pen or the entire electronic pen.

The amount by which a preset value increases or decreases may vary according to a touch input speed with respect to the touch pad or a rotational speed of the rotation of the at least a part of the electronic pen or the entire electronic pen.

The executing of a preset operation may include: determining an orientation of the electronic pen; and executing the preset operation according to the orientation of the electronic pen.

The method may further include receiving a second input for selecting at least one of an area, field, task, or application to execute the preset operation, wherein the executing of a preset operation includes executing the preset operation with respect to at least one of the area, field, task, or application selected according to the second input.

The method may further include: receiving a third input of selecting a point on a screen displayed to a user; and receiving, while receiving the third user input, a fourth input of moving the electronic pen, wherein the executing of a preset operation includes moving, according to the fourth input, at least a portion of a screen displayed to the user or the entire screen with respect to the point.

The method may further include: receiving a fifth input via movement of the electronic pen; and executing a preset operation based on the fifth input.

The executing of a preset operation may include rendering a two-dimensional image or a three-dimensional image.

The executing of a preset operation may include measuring a movement distance of the electronic pen.

The receiving of the fifth input may include receiving the fifth input based on at least one of an orientation, a direction, a movement speed, a movement period of the electronic pen, or a number of rotations of a rolling ball tip.

The method may further include: receiving a sixth input via the electronic pen; and undoing execution of the preset operation based on the sixth input.

The method may further include: displaying an image for calibration of the electronic pen; receiving a seventh input regarding the image via the electronic pen; and transmitting a result regarding the seventh input to the electronic pen.

The method may further include: selecting a target device via the electronic pen; connecting to the target device; and transmitting or receiving information to or from the target device.

The selecting of a target device via the electronic pen may include transmitting at least one of an infrared signal or an ultrasound signal to the target device using the electronic pen.

The connecting to the target device may include: receiving an initial connection message from the target device; and performing connection to the target device based on the initial connection message.

The connecting to the target device may include connecting to the target device through at least one of Bluetooth, Wireless Fidelity (WiFi), WiFi Direct (WFD), Near-Field Communication (NFC), or Ultra WideBand (UWB).

The transmitting or receiving information to or from the target device may include transmitting or receiving at least one of control information or status information of the target device.

According to an example embodiment of the disclosure, an electronic device configured to execute an operation based on an input via an electronic pen is included, the electronic device including: a communicator comprising circuitry configured to communicate with the electronic pen; at least one memory storing a program for executing an operation based on an input via the electronic pen; and at least one processor configured to execute the program to control the electronic device to: connect to the electronic pen, receive a first input via a touch input to a touch pad or at least one operation of a rotation of at least a part of the electronic pen or the entire electronic pen, and execute a preset operation based on the first input.

The at least one processor may be further configured to control the electronic device to change a viewpoint of a user on a screen displayed to the user according to a touch input direction with respect to the touch pad or a rotational direction of the rotation of the at least a part of the electronic pen or the entire electronic pen.

The at least one processor may be further configured to control the electronic device to change at least a portion of a screen displayed to a user or the entire screen according to a touch input direction with respect to the touch pad or a rotational direction of the rotation of the at least a part of the electronic pen or the entire electronic pen.

The at least one processor may be further configured to control the electronic device to increase or reduce a preset value according to a touch input direction with respect to the touch pad or a rotational direction of the rotation of the at least a part of the electronic pen or the entire electronic pen.

The at least one processor may be further configured to control the amount by which a preset value increases or decreases to vary according to a touch input speed with respect to the touch pad or a rotational speed of the rotation of the at least a part of the electronic pen or the entire electronic pen.

The at least one processor may be further configured to control the electronic device to determine an orientation of the electronic pen and execute the preset operation according to the orientation of the electronic pen.

The at least one processor may be further configured to control the electronic device to receive a second input for selecting at least one of an area, field, task, or application and to execute the preset operation and to execute the preset operation on at least one of the area, field, task, or application selected according to the second input.

The at least one processor may be further configured to control the electronic device to receive a third input of selecting a point on a screen displayed to a user and to receive a fourth input of moving the electronic pen while receiving the third input, and to move, according to the fourth input, at least a portion of the screen displayed to the user or the entire screen with respect to that point.

The at least one processor may be further configured to control the electronic device to receive a fifth input via movement of the electronic pen and execute a preset operation based on the fifth input.

The at least one processor may be further configured to control the electronic device to receive a sixth input via the electronic pen and undo execution of the preset operation based on the sixth input.

The at least one processor may be further configured to control the electronic device to display an image for calibration of the electronic pen, receive a seventh input regarding the image via the electronic pen, and transmit a result of the seventh input to the electronic pen.

The at least one processor may be further configured to control the electronic device to render a two-dimensional image or a three-dimensional image.

The at least one processor may be further configured to control the electronic device to measure a movement distance of the electronic pen.

The at least one processor may be further configured to control the electronic device to receive the fifth input based on at least one of an orientation, a direction, a movement speed, a movement period of the electronic pen, or a number of rotations of a rolling ball tip.

The at least one processor may be further configured to control the electronic device to select a target device via the electronic pen, connect to the target device, and transmit or receive information to or from the target device.

The at least one processor may be further configured to control the electronic device to transmit at least one of an infrared signal or an ultrasound signal to the target device using the electronic pen.

The at least one processor may be further configured to control the electronic device to receive an initial connection message from the target device and perform connection to the target device based on the initial connection message.

The at least one processor may be further configured to control the electronic device to connect to the target device through at least one of Bluetooth, WiFi, WFD, NFC, or UWB.

The at least one processor may be further configured to control the electronic device to transmit or receive at least one of control information or status information of the target device.

According to an example embodiment of the disclosure, an electronic device for executing an operation based on a user input via an electronic pen, and an operating method of the electronic device may be provided.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example in which an electronic device receives a user input via an electronic pen according to various embodiments;

FIG. 2 is a diagram illustrating an electronic pen according to various embodiments;

FIG. 3 is a block diagram illustrating an example configuration of an electronic pen according to various embodiments;

FIG. 4 is a flowchart illustrating an example method of operating an electronic device executing an operation based on a user input via an electronic pen, according to various embodiments;

FIG. 5 is a diagram illustrating an example user input method of an electronic pen, according to various embodiments;

FIG. 6 is a diagram illustrating an example configuration of an electronic pen for supporting a user input method of the electronic pen, according to various embodiments;

FIG. 7 is a diagram illustrating an example user input method of an electronic pen, according to various embodiments;

FIG. 8 is a diagram illustrating an example configuration of an electronic pen for supporting a user input method of the electronic pen, according to various embodiments;

FIG. 9 is a diagram illustrating an example user input method of an electronic pen, according to various embodiments;

FIG. 10 is a diagram illustrating an example configuration of an electronic pen for supporting a user input method of the electronic pen, according to various embodiments;

FIG. 11 is a diagram illustrating an example user input method of an electronic pen, according to various embodiments;

FIG. 12 is a diagram illustrating an example structure of an electronic pen for supporting a user input method of the electronic pen, according to various embodiments;

FIG. 13 is a diagram illustrating an example user input method of an electronic pen, according to various embodiments;

FIG. 14 is a diagram illustrating an example user input method of an electronic pen, according to various embodiments;

FIG. 15 is a diagram illustrating an example operation of an electronic device based on a user input of an electronic pen, according to various embodiments;

FIG. 16 is a diagram illustrating an example operation of an electronic device based on a user input of an electronic pen, according to various embodiments;

FIG. 17 is a diagram illustrating an example operation of an electronic device based on a user input of an electronic pen, according to various embodiments;

FIG. 18 is a diagram illustrating an example operation of an electronic device based on a user input of an electronic pen, according to various embodiments;

FIG. 19 is a diagram illustrating an example operation of an electronic device based on a user input of an electronic pen, according to various embodiments;

FIG. 20 is a diagram for illustrating an example operation of an electronic device based on a user input of an electronic pen, according to various embodiments;

FIG. 21 is a diagram illustrating an example operation of an electronic device based on a user input of an electronic pen, according to various embodiments;

FIG. 22 is a diagram illustrating an example operation of an electronic device based on a user input of an electronic pen, according to various embodiments;

FIG. 23 is a flowchart illustrating an example method of operating an electronic device executing an operation based on a user input via an electronic pen, according to various embodiments;

FIG. 24 is a diagram illustrating an example user input method of an electronic pen, according to various embodiments;

FIG. 25 is a diagram illustrating an example user input method of an electronic pen, according to various embodiments;

FIG. 26 is a diagram illustrating an example structure of an electronic pen for supporting a user input method of the electronic pen, according to various embodiments;

FIG. 27 is a diagram illustrating an example method of undoing a user input of an electronic pen, according to various embodiments;

FIG. 28 is a diagram illustrating an example method of undoing a user input of an electronic pen, according to various embodiments;

FIG. 29 is a diagram illustrating an example method of undoing a user input of an electronic pen, according to various embodiments;

FIG. 30 is a diagram illustrating an example method of calibrating an electronic pen, according to various embodiments;

FIG. 31 is a flowchart illustrating an example method of operating an electronic device executing an operation based on a user input via an electronic pen, according to various embodiments;

FIG. 32 is a diagram illustrating an example structure of an electronic pen for supporting a user input method of the electronic pen, according to various embodiments;

FIG. 33 is a signal flow diagram illustrating an example connection method with respect to a target device, according to various embodiments;

FIG. 34 is a diagram illustrating an example user input method of an electronic pen, according to various embodiments;

FIG. 35 is a diagram illustrating an example user input method of an electronic pen, according to various embodiments;

FIG. 36 is a diagram illustrating an example user input method of an electronic pen, according to various embodiments;

FIG. 37 is a block diagram illustrating an example configuration of an electronic device according to various embodiments; and

FIG. 38 is a block diagram illustrating an example configuration of an electronic device according to various embodiments.

### DETAILED DESCRIPTION

Hereinafter, various example embodiments of the disclosure will be described more fully with reference to the accompanying drawings. This disclosure may, however, be embodied in many different forms and should not be construed as limited to the embodiments set forth herein. Also, elements not related to description may be omitted in the drawings for clear description of the disclosure, and like reference numerals in the drawings denote like elements throughout the specification.

Throughout the disclosure, the expression “at least one of a, b or c” indicates only a, only b, only c, both a and b, both a and c, both b and c, all of a, b, and c, or variations thereof.

In the disclosure, it will also be understood that when an element is referred to as being “connected to” another element, it can be directly connected to the other element, or it can be electrically connected to the other element and intervening elements may be present. It will also be understood that when a component “includes” an element, unless there is another opposite description thereto, it should be understood that the component does not exclude another element but may further include another element.

Furthermore, the connecting lines, or connectors shown in the various figures presented are intended to represent example functional relationships and/or physical or logical couplings between the various elements. It should be noted that many alternative or additional functional relationships, physical connections or logical connections may be present in a practical device.

The phrases in the disclosure such as “in some embodiments” or “in an embodiment” do not necessarily indicate the same embodiment.

Various embodiments of the disclosure may be described in terms of functional block components and various processing steps. Some or all of such functional blocks may be realized by any number of hardware and/or software components configured to perform the specified functions. For example, functional blocks according to the disclosure may be realized by at least one microprocessor or circuit components for certain functions. In addition, for example, the functional blocks according to the disclosure may be implemented with any programming or scripting language. The functional blocks may be implemented in algorithms that execute on one or more processors. Furthermore, the disclosure could employ any number of techniques according to the related art for electronics configuration, signal processing and/or data processing and the like. The words “mechanism” and “element” are used broadly and are not limited to mechanical or physical embodiments.

In the disclosure, a user input may include, for example, a touch input, a button input, a motion input, a multimodal input, or the like, but is not limited thereto.

A touch input according to the disclosure may refer, for example, to a touch gesture made by a user on a touch screen, a touch button, a touch pad or the like, using hand or an electronic pen to control an electronic device or the electronic pen. Examples of a touch input may include a tap input, a touch & hold input, a double tap input, a drag input, a panning input, a flicking input, a drag and drop input, and a swipe input, but are not limited thereto.

A button input in the disclosure may refer, for example, to an input of controlling, by a user, an electronic device or an electronic pen using a physical button attached to the electronic device or the electronic pen.

A motion input in the disclosure may refer, for example, to a motion applied by a user to an electronic device or an electronic pen to control the electronic device or the electronic pen. For example, a motion input may include an input, by a user, of rotating an electronic device or an electronic pen, tilting the electronic device or the electronic pen, moving the electronic device or the electronic pen vertically or horizontally, or shaking the electronic device or the electronic pen. An electronic device or an electronic pen may detect a motion preset by a user, using an acceleration sensor, a tilt sensor, a gyro sensor, a 3-axis magnetic sensor or the like.

In the disclosure, a multimodal input may refer, for example, to a combination of at least two input methods. For example, an electronic device or an electronic pen may receive a touch input or a motion input by a user or a touch input or a voice input by a user. In addition, an electronic device or an electronic pen may receive a touch input and an eyeball input by a user. An eyeball input refers to an input, by a user, of adjusting eye blinking, a gaze position, or a movement speed of the eyeball, to control an electronic device or an electronic pen. The above-described input methods are merely examples for describing a multimodal input, and the multimodal input is not limited thereto.

Hereinafter, the disclosure will be described in greater detail with reference to the attached drawings.

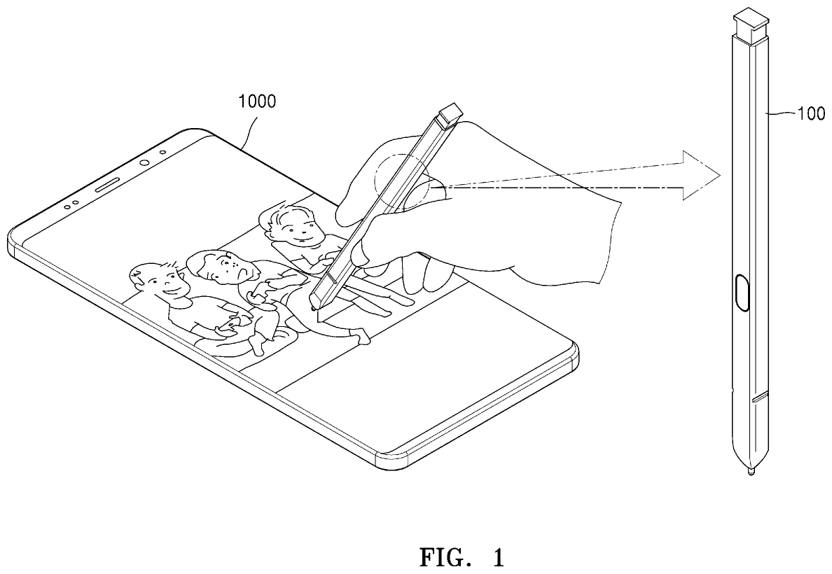

FIG. 1 is a diagram illustrating an example in which an electronic device receives a user input via an electronic pen according to various embodiments.

As illustrated in FIG. 1, an electronic device 1000 according to an embodiment of the disclosure may receive a user input via an electronic pen 100. The electronic device 1000 may execute a preset operation based on the user input received via the electronic pen 100.

According to an embodiment of the disclosure, a user input may include a touch input, a button input, a motion input, a multimodal input, or the like, but is not limited thereto. For example, when a user performs an operation of rotating or shaking the electronic pen 100, the electronic device 1000 may perform a preset operation according to the above operation. Also, when a user performs an operation of touching a touch pad attached to the electronic pen 100 or rotating a track ball, the electronic device 1000 may perform a preset operation according to the above operation. Also, when a user selects a point on a screen displayed to a user, using a physical button or a touch button of the electronic pen 100 and moves the electronic pen 100, the electronic device 1000 may perform a preset operation according to the movement. Furthermore, when a user presses a physical button or a touch button of the electronic pen 100, a target device pointed by the electronic pen 100 may be selected to perform a preset operation. However, without being limited to the above examples, the electronic device 1000 may perform a preset operation based on various user inputs received via the electronic pen 100.

According to an embodiment of the disclosure, the electronic device 1000 may perform various operations. For example, the electronic device 1000 may receive a user input to change a viewpoint of a user on a screen displayed to the user or rotate at least a portion of the screen displayed to the user or the entire screen. In addition, the electronic device 1000 may receive a user input to increase or reduce a preset value. In addition, the electronic device 1000 may receive a user input to render a two-dimensional image or a three-dimensional image or measure a movement distance. In addition, the electronic device 1000 may receive a user input to undo execution of a preset operation or perform an operation for calibration of an electronic pen. In addition, the electronic device 1000 may receive a user input to select a target device and connect to the selected target device and transmit or receive information.

The electronic device 1000 according to an embodiment of the disclosure may be a user terminal device. For example, the electronic device 1000 may be a smart phone, a smart TV, a mobile phone, a personal digital assistant (PDA), a laptop, a media player, a global positioning system (GPS) device, an electronic book (e-book) device, a terminal for digital broadcasting, a navigation device, a kiosk, an MP3 player, a digital camera, and other mobile or non-mobile computing devices, but is not limited thereto. In addition, the electronic device 1000 may include various devices capable of receiving a touch input, such as an electronic blackboard, a touch table, or the like. In the disclosure, for convenience of description, an operation of the electronic device 1000 will be described using a smart phone as an example, but the disclosure is not limited thereto.

Also, the electronic pen 100 may be a pen-shaped electronic device used to control the electronic device 1000. A user may control the electronic device 1000 through various input methods using the electronic pen 100.

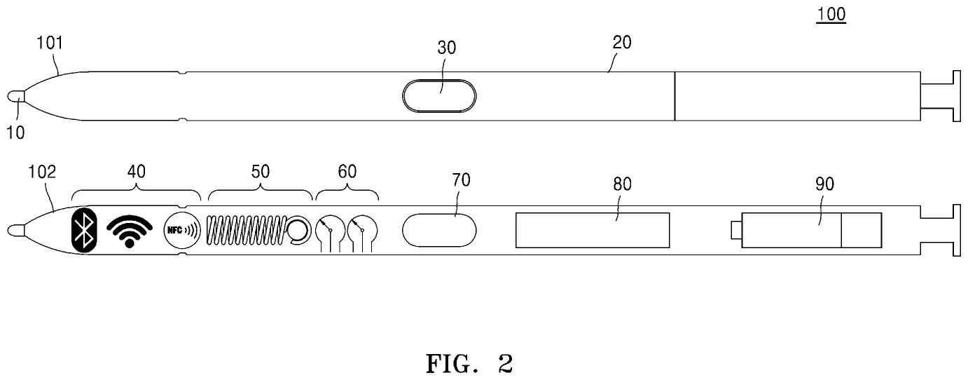

FIG. 2 is a diagram illustrating an example electronic pen according to various embodiments.

Referring to FIG. 2, an electronic pen 101 is illustrated to describe an aspect of the external appearance of an electronic pen, and an electronic pen 102 is illustrated to describe an internal structure of an electronic pen.

In respect of the external appearance of the electronic pen 101, the electronic pen 101 may include a tip 10 and a main body 20. The tip 10 may be coupled to the main body 20 or formed as a portion of the main body 20, and is a portion where an actual touch is made with a touch object such as a touch screen, a touch button, or a touch pad. In an embodiment of the disclosure, to detect a pen pressure according to a user input, the tip 10 may be configured to contact a sensor in the main body 20 or to transfer a pen pressure using another component. In addition, to enable replacement of the tip 10, the tip 10 may be detachably coupled to the main body 20.

The main body 20 may have a long rod-shape in a pen shape. According to an embodiment of the disclosure, an internal portion of the main body 20 may include empty space, and internal components of the electronic pen 100 may be included in the space. The electronic pen 100 may be carried by being accommodated in the electronic device 1000 or attached to the electronic device 1000. The main body 20 may be formed in a shape to be accommodated in the electronic device 1000 or attached to the electronic device 1000. For example, the main body 20 may include a groove used to accommodate the electronic pen 100 and couple the electronic pen 100 to the electronic device 1000. At least a portion of the main body 20 may be formed to have magnetic properties or may be formed of a magnetic material to be attached to the electronic device 1000. According to an embodiment of the disclosure, the main body 20 of the electronic pen 101 may include a button 30 for a user input. The button 30 may include a physical button, a touch button, or the like, but is not limited thereto. The button 30 may be formed at various positions on the main body 20.

While the external appearance of the electronic pen 101 is described above, the electronic pen 101 is not limited to the above appearance and may have other various shapes.

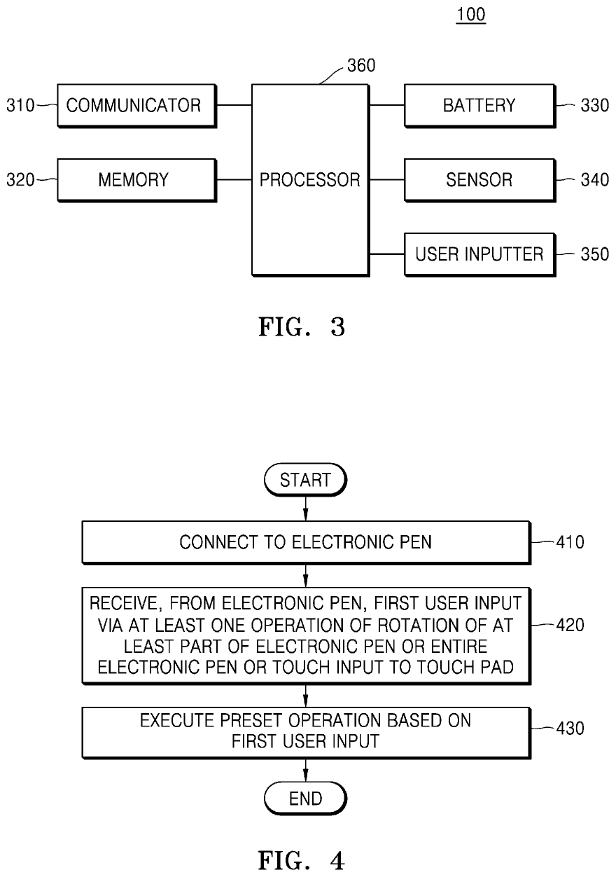

In regard to the internal components of the electronic pen 102, the electronic pen 102 may include a communicator (e.g., including communication circuitry) 40 for communicating with an external device, a pen pressure sensor 50 for detecting a pen pressure, various sensors 60 including, for example, an acceleration sensor, a tilt sensor, a gyro sensor, a magnetic field sensor, or the like, a user inputter (e.g., including input circuitry) 70, a processor (e.g., including processing circuitry) 80, a battery 90, or the like. The internal components as above will be described in detail with reference to FIG. 3.

FIG. 3 is a block diagram illustrating an example configuration of an electronic pen according to various embodiments.

Referring to FIG. 3, an electronic pen 100 according to an embodiment of the disclosure may include a communicator (e.g., including communication circuitry) 310, a memory 320, a battery 330, a sensor 340, a user inputter (e.g., including input circuitry) 350, and a processor (e.g., including processing circuitry) 360. However, not all of the illustrated components are essential components. That is, the electronic pen 100 may be implemented using more components or fewer components than the components illustrated in FIG. 3.

The communicator 310 may include various communication circuitry and communicate with an external device. The communicator 310 may transfer a signal or data received from an external device to the processor 360 or transmit a signal or data generated in the processor 360 to an external device. For example, a communication module may be in the form of a chipset or a sticker/barcode including information needed for communication (e.g., a sticker including a Near-Field Communication (NFC) tag). Also, the communicator 310 may include one or more components for communicating with an external device. That is, the communicator 310 may include a communication module supporting at least one of various wired or wireless communications methods. According to an embodiment of the disclosure, the communicator 310 may include a short-range wireless communicator to communicate with an electronic device 1000. The short-range wireless communicator may include an NFC unit, a wireless local area network (WLAN, WiFi) communicator, a Zigbee communicator, an Infrared Data Association (IrDA) communicator, a Wi-Fi Direct (WFD) communicator, a Ultra Wide Band (UWB) communicator, an Ant+ communicator, a ultrasound communicator, or the like, but is not limited thereto.

According to an embodiment of the disclosure, the communicator 310 may communicate with the electronic device 1000. In addition, the communicator 310 may communicate with a target device which is another external device.

The memory 320 may store a program for processing or controlling the processor 360 and store data input to the electronic pen 100 or output from the electronic pen 100. Programs stored in the memory 320 may be classified into a plurality of modules according to their functions.

The memory 320 may include at least one type of storage medium selected from a flash memory type storage medium, a hard disk type storage medium, a multimedia card micro type storage medium, a card type memory (e.g., Secure Digital (SD) or extreme Digital (xD) memory), a random access memory (RAM), a static random access memory (SRAM), a read-only memory (ROM), an electrically erasable programmable read-only memory (EEPROM), a programmable read-only memory (PROM), a magnetic memory, a magnetic disc, or an optical disc.

The battery 330 supplies power to the electronic pen 100. According to an embodiment of the disclosure, the battery 330 supplies power needed for operation of the electronic pen 100 and is rechargeable using a wired or wireless method. The battery 330 may be charged by receiving power from the electronic device 1000. For example, when the electronic pen 100 is accommodated in the electronic device 1000 or attached to the electronic device 1000, the battery 330 may be charged by receiving power from the electronic device 1000. However, the disclosure is not limited thereto, and the battery 330 may also receive power from other external power supply devices.

The sensor 340 may detect a state of the electronic pen 100 or a state of the surroundings of the electronic pen 100 and transfer the detected information to the processor 360.

The sensor 340 may include, for example, a pen pressure sensor, a magnetic sensor, an acceleration sensor, a temperature/humidity sensor, an infrared sensor, an ultrasound sensor, a gyroscopic sensor, a position sensor (for example, a GPS, an atmospheric pressure sensor, a proximity sensor, an RGB sensor (illuminance sensor), or the like, but is not limited thereto. The functions of the respective sensors may be intuitively inferred from their names by one of ordinary skill in the art, and thus detailed description may not be provided here.

The user inputter 350 may include various circuitry allowing a user to input data for controlling the electronic pen 100. For example, the user inputter 350 may include a dome switch, a physical button, a touch button, a touchpad (e.g., a touch capacitive type touch pad, a pressure resistive type touch pad, an infrared beam detecting type touch pad, a surface ultrasonic wave conduction type touch pad, an integral strain gauge type touch pad, a piezo-effect type touch pad, etc.), a jog wheel, a jog switch, a rolling ball, a track ball, and the like, but is not limited thereto.

The processor 360 may include various processing circuitry and controls an overall operation of the electronic pen 100. For example, the processor 360 may control the communicator 310, the battery 330, the sensor 340, and the user inputter 350 by executing programs stored in the memory 320. The processor 360 may include at least one processor.

According to an embodiment of the disclosure, the processor 360 may receive a user input via rotation of at least some of the electronic pen 100 or the entire electronic pen 100 and process the same. In addition, the processor 360 may receive a user input via a touch input to a touch pad and process the same. The processor 360 may detect rotational speed of rotation of at least a part of the electronic pen 100 or the entire electronic pen 100 or a touch input speed with respect to a touch pad, and process a user input according to the detected speed. Furthermore, the processor 360 may detect an orientation of the electronic pen 100 and process a user input according to the detected orientation.

According to an embodiment of the disclosure, the processor 360 may receive a user input via a physical button or a touch button and process the same. Also, the processor 360 may receive a user input via a touch on a touch screen or a touch button of the electronic device 1000 and process the user input. Furthermore, the processor 360 may detect movement of the electronic pen 100 and process a user input according to the detected movement.

According to an embodiment of the disclosure, the processor 360 may receive a user input by detecting movement of the electronic pen 100 and process the user input. For example, the processor 360 may receive a user input based on an orientation, a direction, a movement speed, a movement period of the electronic pen 100, or a number of rotations of a rolling ball tip, or the like and process the user input.

According to an embodiment of the disclosure, the processor 360 may receive a user input to control the electronic pen 100 to select a target device. Here, the processor 360 may control the electronic pen 100 to transmit at least one of an infrared signal or an ultrasound signal to a target device.

FIG. 4 is a flowchart illustrating an example method of operating an electronic device executing an operation based on a user input via an electronic pen, according to various embodiments.

In operation 410, the electronic device 1000 may connect to the electronic pen 100. According to an embodiment of the disclosure, the electronic device 1000 may connect to the electronic pen 100 via NFC, WLAN, Zigbee, IrDA, Wi-Fi, WFD, UWB, or the like.

In operation 420, the electronic device 1000 may receive, from the electronic pen 100, a first user input via rotation of at least a part of the electronic pen 100 or the entire electronic pen 100. According to an embodiment of the disclosure, at least a part of the electronic pen 100 or the entire electronic pen 100 may rotate clockwise or counter-clockwise, and a user input value may vary according to a rotational direction thereof. Also, a user input value may vary according to a rotational speed of the at least a part of the electronic pen 100 or the entire electronic pen 100. According to an embodiment of the disclosure, the electronic device 1000 may receive, from the electronic pen 100, a first user input via a touch input to a touch pad of the electronic pen 100. A user input value of a touch input to a touch pad of the electronic pen 100 may vary according to a touch input direction, a touch input speed, or the like.

In operation 430, the electronic device 1000 may execute a preset operation based on the first user input. According to an embodiment of the disclosure, the electronic device 1000 may change a viewpoint of a user on a screen displayed to the user according to a rotational direction of at least a part of the electronic pen 100 or the entire electronic pen 100. Also, the electronic device 1000 may change at least a portion of a screen displayed to a user or the entire screen according to a rotational direction of the at least a part of the electronic pen 100 or the entire electronic pen 100. For example, when the at least a part of the electronic pen 100 or the entire electronic pen 100 rotate clockwise or counter-clockwise, the electronic device 1000 may rotate a viewpoint of a user clockwise or counter-clockwise on a screen displayed to the user or rotate or move at least a portion of the screen displayed to the user or the entire screen, clockwise or counter-clockwise. Furthermore, according to an embodiment of the disclosure, the electronic device 1000 may increase or reduce a preset value according to a rotational direction of at least a part of the electronic pen 100 or the entire electronic pen 100. For example, when the at least a part of the electronic pen 100 or the entire electronic pen 100 rotate clockwise or counter-clockwise, a preset value may be increased or reduced. Here, the amount by which a preset value increases or decreases may vary according to a rotational speed of the at least a part of the electronic pen 100 or the entire electronic pen 100. For example, when the at least a part of the electronic pen 100 or the entire electronic pen 100 rotate at a high speed, a preset value may be increased or reduced quickly or the amount by which the preset value is increased or decreased may be increased. When the at least a part of the electronic pen 100 or the entire electronic pen 100 rotate at a low speed, a preset value may be increased or reduced slowly or the amount by which the preset value is increased or decreased may be reduced.

According to an embodiment of the disclosure, the electronic device 1000 may change a viewpoint of a user on a screen displayed to the user according to a touch input to a touch pad of the electronic pen 100. Also, the electronic device 1000 may change at least a portion of a screen displayed to a user or the entire screen according to a touch input to a touch pad of the electronic pen 100. For example, dragging, panning, flicking, or swiping a touch pad of the electronic pen 100 to the left, the right, upwards or downwards, the electronic device 1000 may turn a viewpoint of a user to the left, to the right, upwards, or downwards on a screen displayed to the user or may rotate or move at least a portion of the screen displayed to the user or the entire screen to the left, to the right, upwards, or downwards. Furthermore, according to an embodiment of the disclosure, the electronic device 1000 may increase or reduce a preset value according to a touch input to a touch pad of the electronic pen 100. For example, when dragging, panning, flicking, or swiping the touch pad of the electronic pen 100 to the left, to the right, upwards, or downwards, a preset value may be increased or reduced. Here, the amount by which the preset value is increased or decreased may vary according to a touch input speed with respect to the touch pad of the electronic pen 100. For example, when dragging, panning, flicking, or swiping the touch pad of the electronic pen 100 quickly, a preset value may be increased or reduced quickly or the amount by which the preset value is increased or decreased may be increased. When dragging, panning, flicking, or swiping the touch pad of the electronic pen 100 slowly, a preset value may be increased or reduced slowly or the amount by which the preset value is increased or decreased may be reduced.

According to an embodiment of the disclosure, the electronic device 1000 may determine an orientation of the electronic pen 100, and execute a preset operation according to the orientation of the electronic pen 100. For example, when the electronic pen 100 is stood perpendicular to the ground, the electronic device 1000 may change a viewpoint of a user on a screen displayed to the user according to a rotational direction of at least a part of the electronic pen 100 or the entire electronic pen 100 or rotate or move at least a portion of the screen displayed to the user or the entire screen to the left or to the right. Alternatively, when the electronic pen 100 is placed horizontally on the ground, the electronic device 1000 may change a viewpoint of a user on a screen displayed to the user according to a rotational direction of at least a part of the electronic pen 100 or the entire electronic pen 100 or rotate or move at least a portion of the screen displayed to the user or the entire screen, upwards or downwards.

According to an embodiment of the disclosure, the electronic device 1000 may receive a second user input for selecting at least one of an area, a field, a task, or an application for executing a preset operation. For example, the electronic device 1000 may receive a touch input of the electronic pen 100 to an area, a field, or the like, displayed on a touch screen of the electronic device 1000, that is, a second user input. However, the second user input is not limited to a touch input, but may include various user inputs. According to an embodiment of the disclosure, the electronic device 1000 that has received a second user input may execute a preset operation with respect to at least one of an area, a field, a task, or an application selected according to the second user input. For example, when a partial area of a displayed screen is selected by the second user input, a preset operation may be executed on that area.

According to an embodiment of the disclosure, the electronic device 1000 may receive a third user input of selecting a point on a screen displayed to a user, and while receiving the third user input, the electronic device 1000 may receive a fourth user input of moving the electronic pen 100. For example, the electronic device 1000 may receive a touch input of the electronic pen 100 to a point displayed on a touch screen of the electronic device 1000, that is, the third user input. Also, the electronic device 1000 may receive the fourth user input by detecting movement of the electronic pen 100. However, the third user input and the fourth user input are not limited to the above-described user input methods, but may include various user inputs.

According to an embodiment of the disclosure, the electronic device 1000 that has received a third user input and a fourth user input may move at least a portion of a screen displayed to a user or the entire screen according to the fourth user input, with respect to the point selected via the third user input. For example, the electronic device 1000 may select a point on a displayed screen, via a third user input of selecting a particular point, and may rotate or move at least a portion of the screen displayed to a user or the entire screen, according to a fourth user input of moving the electronic pen 100.

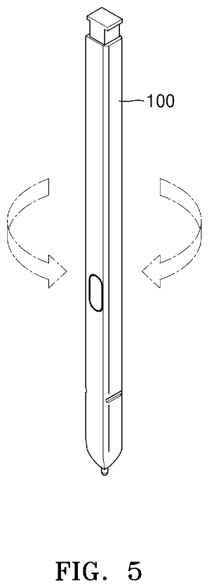

FIG. 5 is a diagram illustrating an example user input method of an electronic pen, according to various embodiments.

Referring to FIG. 5, a method of receiving a user input via rotation of the electronic pen 100 is illustrated. The electronic device 1000 may receive, from the electronic pen 100, a user input via rotation of the electronic pen 100. According to an embodiment of the disclosure, the electronic pen 100 may rotate clockwise or counter-clockwise, and a user input value may vary according to a rotational direction of the electronic pen 100. For example, a user input value when the electronic pen 100 rotates clockwise may be the opposite of that when the electronic pen 100 rotates counter-clockwise. For example, when the electronic pen 100 rotates clockwise, a positive value may be received as a user input. When the electronic pen 100 rotates counter-clockwise, a negative value may be received as a user input.

According to an embodiment of the disclosure, a user input value may vary according to a rotational speed of the electronic pen 100. For example, a variation in a user input value may vary according to a rotational speed of the electronic pen 100. For example, when rotating the electronic pen 100 quickly, a user input value may be increased or reduced quickly or the amount by which the user input value is increased or decreased may be increased. When rotating the electronic pen 100 slowly, a user input value may be increased or reduced slowly or the amount by which the user input value is increased or decreased may be reduced. For example, when the electronic pen 100 rotates one time at a normal speed and thus a value of x is received as a user input, then when the electronic pen 100 rotates ten times, a value of 10× is received as a user input. When rotating the electronic pen 100 quickly, the time taken to reach a value of 10× from a value of x may be reduced, and the amount by which a user input value is increased may be increased and the value of 10× may be reached with fewer number of rotations than ten times. When rotating the electronic pen 100 slowly, a time taken to reach a value of 10× from a value x may be increased, and the amount by which a user input value is increased may be reduced and the value of 10× may be reached with a greater number of rotations than ten times.

According to an embodiment of the disclosure, a user input value may vary according to a rotation amount of the electronic pen 100. A rotation amount of the electronic pen 100 may be proportional to a user input value. For example, when the electronic pen 100 rotates one time to receive a value of x as a user input, then when the electronic pen 100 rotates twice, a value of 2× may be received as a user input. However, the disclosure is not limited thereto, and a proportional relationship between a rotation amount of the electronic pen 100 and a user input value may also vary according to a rotation amount of the electronic pen 100. For example, a rotation amount of the electronic pen 100 of between one to five times may be proportional to a user input value. However, when a rotation amount of the electronic pen 100 is six to ten times, a user input value may be greater than a value proportional to the rotation amount of the electronic pen 100. For example, when the electronic pen 100 rotates one time and thus a value of x is received as a user input, then a value of 5× is received as a user input when the electronic pen 100 rotates five times. However, when the electronic pen 100 rotates six times, not a value of 6× is received as a user input, but a value of 6×+α may be received as a user input. A value of a may increase as a rotation amount increases.

According to an embodiment of the disclosure, a user may conveniently input a relatively large value or may input a sophisticated value.

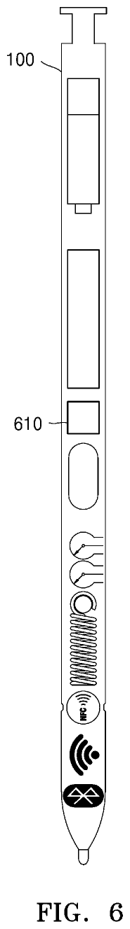

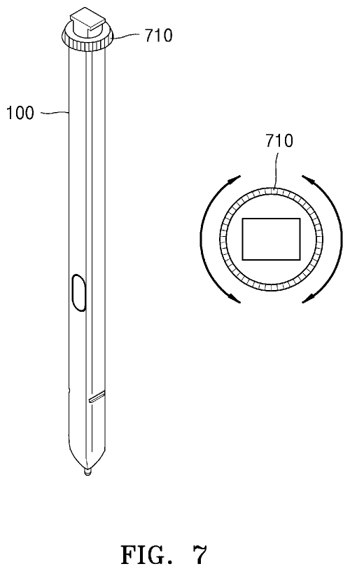

FIG. 6 is a diagram illustrating an example structure of an electronic pen for supporting a user input method of the electronic pen, according to various embodiments.

Referring to FIG. 6, to receive a user input via rotation of an electronic pen 100, the electronic pen 100 may include a device (e.g., a sensor) 610 for detecting rotation of the electronic pen 100 in addition to the at least a part of the electronic pen 100 described with reference to FIGS. 2 and 3. According to an embodiment of the disclosure, the electronic pen 100 may include a magnetic sensor, an acceleration sensor, a gyroscopic sensor, or the like, as the device 610 for detecting rotation of the electronic pen 100. However, the disclosure is not limited thereto, and the electronic pen 100 may include various sensors and devices for detecting rotation of the electronic pen 100. The device 610 for detecting rotation of the electronic pen 100 as described above may be mounted in the main body 20 of the electronic pen 100.

According to an embodiment of the disclosure, the electronic pen 100 may support a method of receiving a user input via rotation of the electronic pen 100 described with reference to FIG. 5, using the device 610 for detecting rotation of the electronic pen 100.

FIG. 7 is a diagram illustrating an example user input method of an electronic pen, according to various embodiments.

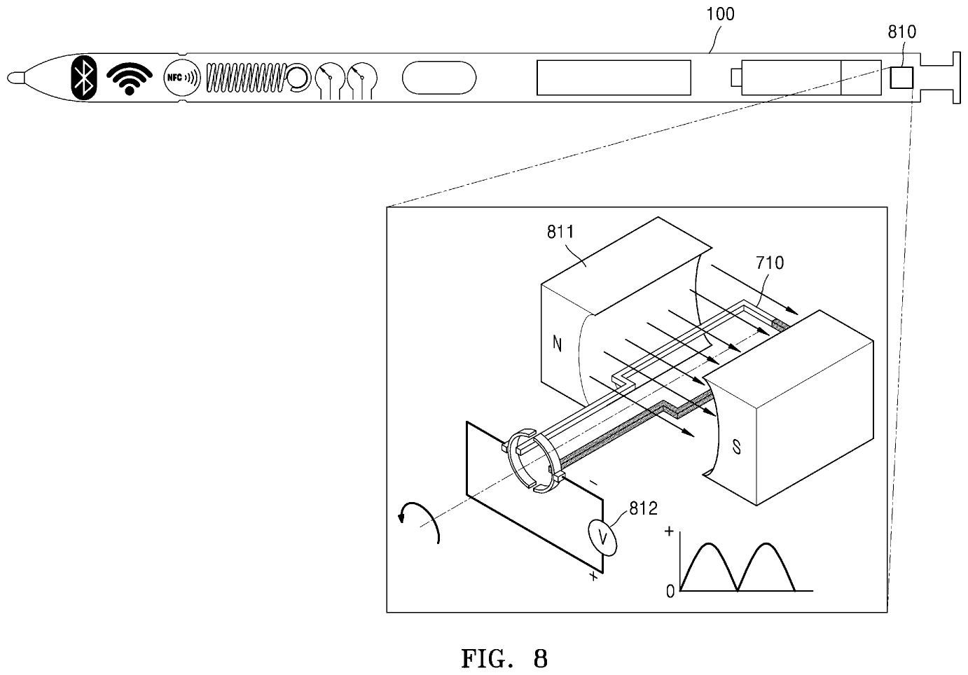

Referring to FIG. 7, a method of receiving a user input via rotation of at least a part 710 of an electronic pen 100 is illustrated. According to an embodiment of the disclosure, at least a part 710 of the electronic pen 100 may include a portion of the main body 20 of the electronic pen 100, a rotational member formed on the main body 20 of the electronic pen 100, or the like. The at least a part 710 of the electronic pen 100 will be described in detail below with reference to FIG. 8.

The electronic device 1000 may receive, from the electronic pen 100, a user input via rotation of the at least a part 710 of the electronic pen 100. According to an embodiment of the disclosure, the at least a part 710 of the electronic pen 100 may rotate clockwise or counter-clockwise, and a user input value may vary according to a rotational direction of the at least a part 710. For example, a user input value when the at least a part 710 of the electronic pen 100 rotate clockwise may be opposite to that when the at least a part 710 of the electronic pen 100 rotate counter-clockwise. For example, when the at least a part 710 of the electronic pen 100 rotates clockwise, a positive value may be received as a user input. When the at least a part 710 of the electronic pen 100 rotate counter-clockwise, a negative value may be received as a user input.

According to an embodiment of the disclosure, a user input value may vary according to a rotational speed of the at least a part 710 of the electronic pen 100. For example, a variation in a user input value may vary according to a rotational speed of the at least a part 710 of the electronic pen 100. For example, when rotating the at least a part 710 of the electronic pen 100 quickly, a user input value may be increased or reduced quickly or the amount by which the user input value is increased or decreased may be increased. When rotating the at least a part 710 of the electronic pen 100 slowly, a user input value may be increased or reduced slowly or the amount by which the user input value is increased or decreased may be reduced. For example, when the at least a part 710 of the electronic pen 100 rotates one time at a normal speed and a value of x is received as a user input, then when the at least a part 710 of the electronic pen 100 rotate ten times, a value of 10× is received as a user input. When rotating the at least a part 710 of the electronic pen 100 quickly, a time taken to reach a value of 10× from a value of x may be reduced, and the amount by which a user input value increases may be increased and the value of 10× may be reached with a fewer number of rotations than ten times. When rotating the at least a part 710 of the electronic pen 100 slowly, a time taken to reach a value of 10× from a value x may be increased, and the amount by which a user input value increases may be reduced and the value of 10× may be reached with a greater number of rotations than ten times.

According to an embodiment of the disclosure, a user input value may vary according to a rotation amount of the at least a part 710 of the electronic pen 100. A user input value may be proportional to a rotation amount of the at least a part 710 of the electronic pen 100. For example, when the at least a part 710 of the electronic pen 100 rotates one time to receive a value of x as a user input, then when the at least a part 710 of the electronic pen 100 rotate twice, a value of 2× may be received as a user input. However, the disclosure is not limited thereto, and a proportional relationship between a rotation amount of the at least a part 710 of the electronic pen 100 and a user input value may also vary according to a rotation amount of the electronic pen 100. For example, a rotation amount of the at least a part 710 of the electronic pen 100 of between one to five times may be proportional to a user input value. However, when a rotation amount of the at least a part 710 of the electronic pen 100 is six to ten times, a user input value may be greater than a value proportional to the rotation amount of the at least a part 710 of the electronic pen 100. For example, when the at least a part 710 of the electronic pen 100 rotates one time and thus a value of is received as a user input, then a value of 5× is received as a user input when the at least a part 710 of the electronic pen 100 rotate five times. However, when the at least a part 710 of the electronic pen 100 rotate six times, not a value of 6× is received as a user input, but a value of 6×+α may be received as a user input. A value of a may increase as a rotation amount increases.

According to an embodiment of the disclosure, a user may conveniently input a relatively large value or may input a sophisticated value.

FIG. 8 is a diagram illustrating an example structure of an electronic pen for supporting a user input method of the electronic pen, according to various embodiments.

Referring to FIG. 8, to receive a user input via rotation of the at least a part 710 of the electronic pen 100, the electronic pen 100 may include a device 810 for detecting rotation of the at least a part 710 of the electronic pen 100 in addition to the at least a part of the electronic pen 100 described with reference to FIGS. 2 and 3.

According to an embodiment of the disclosure, the at least a part 710 of the electronic pen 100 may include a portion of the main body 20 of the electronic pen 100, a rotational member formed on the main body 20 of the electronic pen 100, or the like. When the at least a part 710 of the electronic pen 100 includes a portion of the main body 20 of the electronic pen 100, the portion of the main body 20 of the electronic pen 100, which is rotatable, may be formed at the opposite end to the tip 10 of the electronic pen 100 or in a middle portion of the main body 20 of the electronic pen 100. The position of the portion is not limited thereto and the portion may be formed at various positions on the main body 20 of the electronic pen 100. Also when the at least a part 710 of the electronic pen 100 includes a rotational member formed on the main body 20 of the electronic pen 100, the rotational member may be formed at the opposite end to the tip 10 of the electronic pen 100 or in a middle portion of the main body 20 of the electronic pen 100. The position of the rotational member is not limited thereto and the rotational member may be formed at various positions on the main body 20 of the electronic pen 100.

According to an embodiment of the disclosure, the rotational member may be a ring-shaped member. The ring-shaped member may have various thicknesses. Also, a projection may be formed on the edge of the rotational member to prevent and/or reduce sliding of the rotational member when a user rotates the rotational member. Furthermore, the rotational member may be configured to rotate without artificial resistance, or may include a hook portion at certain angles to generate a resistance with respect to rotation and a clicking sound each time the hook portion is passed. According to an embodiment of the disclosure, when the rotational member is configured to be rotate without artificial resistance, the rotational member may be rotated quickly, and when a hook portion is included, the rotational member may be operated elaborately. In FIG. 7, the electronic pen 100 in which a rotational member is formed at the opposite end to the tip 10 of the electronic pen 100 is illustrated.

In an embodiment of the disclosure, the device 810 for detecting rotation of the at least a part 710 of the electronic pen 100 includes a magnetic member 811, and a sensor 812 for detecting an induced electromotive force generated by the at least a part 710 of the electronic pen 100 while rotating. For example, the sensor 812 for detecting an induced electromotive force may measure a voltage or current, or the like, and the processor 360 of the electronic pen 100 may determine whether the at least a part 710 of the electronic pen 100 is rotated based on the measured voltage or current. However, the disclosure is not limited thereto, and the electronic pen 100 may include various sensors and devices for detecting rotation of the at least a part 710 of the electronic pen 100. The device 810 for detecting rotation of the at least a part 710 of the electronic pen 100 may be mounted in a portion of the main body 20 of the electronic pen 100, the portion corresponding to the at least a part 710 of the electronic pen 100.

According to an embodiment of the disclosure, a method of receiving a user input via rotation of the at least a part 710 of the electronic pen 100 described with reference to FIG. 7 may be supported using the device 810 for detecting rotation of the at least a part 710 of the electronic pen 100.

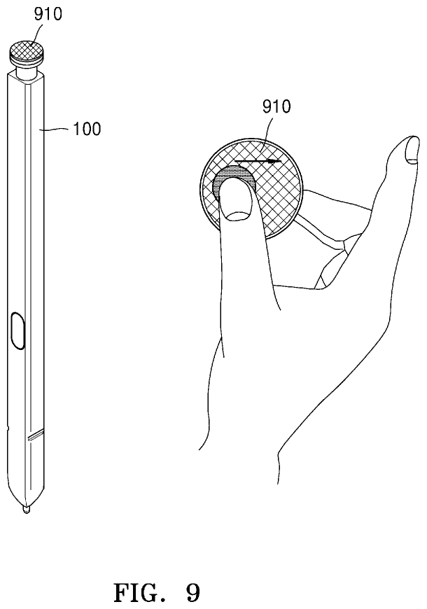

FIG. 9 is a diagram illustrating an example user input method of an electronic pen, according to various embodiments.

Referring to FIG. 9, a method of receiving a user input via a touch input to a touch pad is illustrated. The electronic device 1000 may receive, from the electronic pen 100, a first user input via a touch input to a touch pad of the electronic pen 100. According to an embodiment of the disclosure, a user input value of a touch input to a touch pad 910 of the electronic pen 100 may vary according to a touch input direction, a touch input speed, or the like. According to an embodiment of the disclosure, a touch input may include at least one operation from among dragging, panning, flicking or swiping. Furthermore, a touch input may also include other input operations. Furthermore, a touch input may further include a pressing operation.

According to an embodiment of the disclosure, a user input value may vary according to a direction in which a touch input of a user is received. For example, a user input value may be opposite according to a touch input direction of a user. For example, when a user swipes the touch pad 910 to the left, a positive value may be received as a user input. When a user swipes the touch pad 910 to the right, a negative value may be received as a user input.

According to an embodiment of the disclosure, a user input value may vary according to a speed at which a touch input of a user is received. For example, a variation in a user input value may vary according to a touch speed of a user. For example, when a user swipes the touch pad 910 quickly, a user input value may be increased or reduced quickly or the amount by which the user input value is increased or decreased may be increased. When a user swipes the touch pad 910 slowly, a user input value may be increased or reduced slowly or the amount by which the user input value is increased or decreased may be reduced. For example, when a user swipes the touch pad 910 at a normal speed and thus a value of x is received as a user input, then when the user quickly swipes the touch pad 910, a value of x+α may be received as a user input. When a user quickly swipes the touch pad 910, a time taken to reach a value of x may be shortened, and the amount by which a user input value is increased may be increased and thus the value of x may be reached with a smaller movement. When slowly swiping the touch pad 910, a time taken to reach a value of x may be increased, and the amount by which a user input value is increased may be reduced and thus the value of x may be reached with a greater movement.

According to an embodiment of the disclosure, a user input value may vary according to a degree at which a touch input of a user is received. For example, a user input value may also vary according to a movement distance of a touch input of a user on the touch pad 910. A movement distance of a touch input of a user on the touch pad 910 may be proportional to a user input value. For example, when a user swipes the touch pad 910 by 0.5 cm to receive a value of x as a user input, then when the user swipes the touch pad 910 by a distance of 1 cm, which is twice 0.5 cm, a value of 2× may be received as a user input. However, the disclosure is not limited thereto, and a proportional relationship between a movement distance of a touch input of a user to the touch pad 910 and a user input value may vary according to the movement distance of the touch input. For example, in a distance range between 0 to 1 cm, a movement distance of a touch input of a user is proportional to a user input. However, at a movement distance equal to or greater than 1 cm, a user input value may be greater than a proportional value of the movement distance of the touch input of the user. For example, when a user swipes the touch pad 910 by 0.5 cm, a value of x is received as a user input. However, when the user swipes the touch pad 910 by 1.5 cm, instead of a value of 3×, a value of 3×+α may be received as a user input. A value of a may increase as a rotation amount increases.

While a swiping operation is described as an example of a touch input, the touch input is not limited thereto and may include at least one operation of dragging, panning, flicking, or swiping as described above. Furthermore, a touch input may also include other input operations. For example, a touch input may further include a pressing operation. When a touch input includes a pressing operation, the electronic pen 100 may detect a pressure applied to the touch pad 910 of the electronic pen 100, and the electronic device 1000 may receive, from the electronic pen 100, a result of detecting a pressure, as a first user input. A user input value may vary according to an intensity of the detected pressure.

According to an embodiment of the disclosure, a user may conveniently input a relatively large value or may input a sophisticated value.

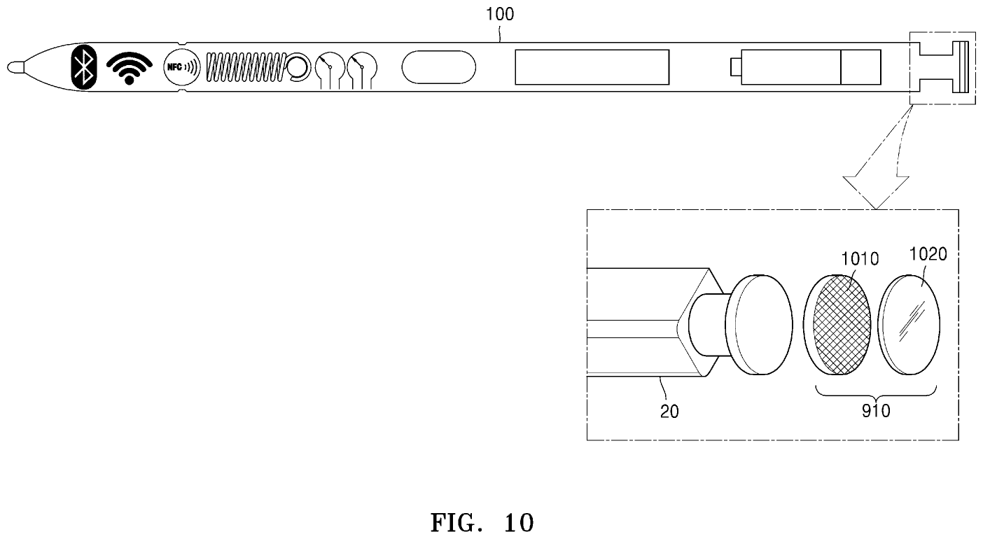

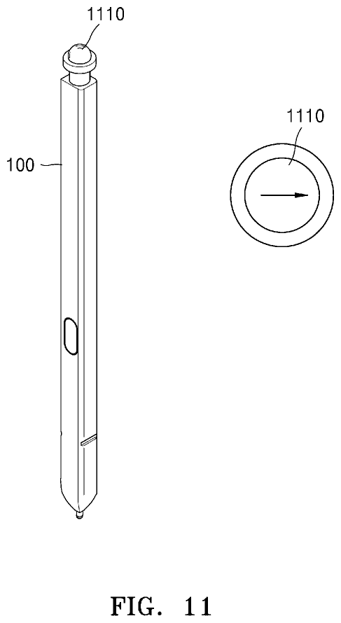

FIG. 10 is a diagram illustrating an example structure of an electronic pen for supporting a user input method of the electronic pen, according to various embodiments.

Referring to FIG. 10, to receive a first user input via a touch input to the touch pad 910 of the electronic pen 100, the electronic pen 100 may include the touch pad 910 in addition to the at least a part of the electronic pen 100 described with reference to FIGS. 2 and 3. The touch pad 910 may include various types of touch pad 910 using, for example, a contact capacitance method, a pressure resistive film method, an infrared detecting method, a surface ultrasonic conduction method, an integrated tension measurement method, a piezo-effective method, and the like.

According to an embodiment of the disclosure, the touch pad 910 may include a touch sensor 1010 and may further include a protector 1020.

The touch sensor 1010 may include various sensors included inside or near the touch pad 910 to detect a touch or a proximity touch of the touch pad 910. The touch sensor 1010 may include various sensors according to an operating method of the touch pad 910. According to an embodiment of the disclosure, a tactile sensor may be included as a sensor for detecting a touch of the touch pad 910. A tactile sensor refers to a sensor that detects contact of a certain object to a degree that is perceivable by humans or even with a higher degree. A tactile sensor may detect various types of information such as roughness of a contact surface, rigidity of a contact object, a temperature of a point of contact, or the like. Also, a proximity sensor may be included as a sensor for detecting a touch of the touch pad 910. A proximity sensor may refer, for example, to a sensor that detects the presence or absence of an object approaching a certain detection surface or an object present nearby the proximity sensor, using a force of an electromagnetic field or infrared rays, without using a mechanical contact. Examples of the proximity sensor may include a transmissive photoelectric sensor, a direct reflective photoelectric sensor, a mirror reflective photoelectric sensor, a high-frequency oscillation proximity sensor, a capacitive proximity sensor, a magnetic proximity sensor, an infrared proximity sensor, and the like. However, the disclosure is not limited thereto, and the touch sensor 1010 may include various sensors according to an operating method of the touch pad 910.

The protector 1020 may include a component for protecting the touch sensor 1010. According to an embodiment of the disclosure, the protector 1020 may include a protective film in the form of a thin film. The protector 1020 may be coupled to the touch sensor 1010, and may be coupled in a layer structure. According to an embodiment of the disclosure, the protector 1020 may not affect an operation of the touch sensor 1010 or may not affect a substantial operation of the touch sensor 1010. For example, when the touch sensor 1010 includes a capacitive proximity sensor, the protector 1020 may not affect an operation of the capacitive proximity sensor or may be formed of a non-conductive and non-magnetic material to have very little effect within an error range. However, the disclosure is not limited thereto, and the protector 1020 may be formed in various forms according to an operating method of the touch pad 910.

According to an embodiment of the disclosure, the electronic pen 100 may support a method of receiving a user input via a touch input to the touch pad 910 described with reference to FIG. 9, using the touch pad 910.

FIG. 11 is a diagram illustrating an example user input method of an electronic pen, according to various embodiments.

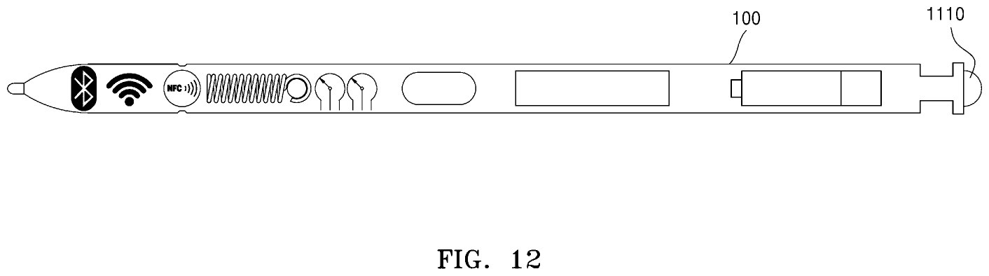

Referring to FIG. 11, a method of receiving a user input via rotation of the at least a part 710 of the electronic pen 100 is illustrated. According to an embodiment of the disclosure, the at least a part 710 of the electronic pen 100 may include a track ball 1110. The track ball 1110 will be described in greater detail below with reference to FIG. 12.

The electronic device 1000 may receive, from the electronic pen 100, a user input via rotation of the track ball 1110. According to an embodiment of the disclosure, the track ball 1110 may rotate to the left, to the right, upwards, or downwards, and a user input value may vary according to a rotational direction of the track ball 1110. For example, a user input value when the track ball 1110 rotates to the left may be opposite to that when rotating to the right or a user input value when the track ball 1110 rotates upwards may be opposite to that when rotating downwards. For example, when the track ball 1110 rotates to the left, a positive value may be received as a user input. When the track ball 1110 rotates to the right, a negative value may be received as a user input.

According to an embodiment of the disclosure, a user input value may vary according to a rotational speed of the track ball 1110. For example, a variation in a user input value may vary according to a rotational speed of the track ball 1110. For example, when rotating the track ball 1110 quickly, a user input value may be increased or reduced quickly or the amount by which the user input value is increased or decreased may be increased. When rotating the track ball 1110 slowly, a user input value may be increased or reduced slowly or the amount by which the user input value is increased or decreased may be reduced. For example, when the track ball 1110 rotates one time at a normal speed and thus a value of x is received as a user input, then when the track ball 1110 rotates ten times, a value of 10× is received as a user input. When rotating the track ball 1110 quickly, a time taken to reach a value of 10× from a value of x may be reduced, and the amount by which a user input value is increased may be increased and the value of 10× may be reached with a fewer number of rotations than ten times. When rotating the track ball 1110 slowly, a time taken to reach a value of 10× from a value x may be increased, and the amount by which a user input value is increased may be reduced and the value of 10× may be reached with a fewer number of rotations than ten times.

According to an embodiment of the disclosure, a user input value may vary according to a rotation amount of the track ball 1110. A rotation amount of the track ball 1110 may be proportional to a user input value. For example, when the track ball 1110 rotates one time to receive a value of x as a user input, then when the track ball 1110 rotates twice, a value of 2× may be received as a user input. However, the disclosure is not limited thereto, and a proportional relationship between a rotation amount of the track ball 1110 and a user input value may also vary according to a rotation amount of the track ball 1110. For example, a rotation amount of the track ball 1110 of between one to five times may be proportional to a user input value. However, when a rotation amount of the track ball 1110 is six to ten times, a user input value may be greater than a value proportional to the rotation amount of the track ball 1110. For example, when the track ball 1110 rotates one time and thus a value of x is received as a user input, then a value of 5× is received as a user input when the track ball 1110 rotates five times. However, when the track ball 1110 rotates six times, not a value of 6× is received as a user input, but a value of 6×+α may be received as a user input. A value of a may increase as a rotation amount increases.

According to an embodiment of the disclosure, a user may conveniently input a relatively large value or may input a sophisticated value.

FIG. 12 is a diagram illustrating an example structure of an electronic pen for supporting a user input method of the electronic pen, according to various embodiments.

Referring to FIG. 12, to receive a user input via rotation of the track ball 1110, the electronic pen 100 may include the track ball 1110 in addition to the at least a part of the electronic pen 100 described with reference to FIGS. 2 and 3.

According to an embodiment of the disclosure, the at least a part 710 of the electronic pen 100 may include the track ball 1110. When the at least a part 710 of the electronic pen 100 includes the track ball 1110, the track ball 1110 may be formed at the opposite end to the tip 10 of the electronic pen 100. The position of the track ball 1110 is not limited thereto and the track ball 1110 may be formed at various positions on the main body 20 of the electronic pen 100. According to an embodiment of the disclosure, the electronic pen 100 may include a sensor for detecting rotation of the track ball 1110. The sensor for detecting rotation of the track ball 1110 may recognize an operation using a mechanical roller or using light. In FIG. 12, the electronic pen 100 in which the track ball 1110 is formed at the opposite end to the tip 10 of the electronic pen 100 is illustrated. However, the disclosure is not limited thereto, and the track ball 1110 may be formed at various positions on the electronic pen 100.

According to an embodiment of the disclosure, the electronic pen 100 may support a method of receiving a user input via rotation of the at least a part 710 of the electronic pen 100 described with reference to FIG. 11, using the track ball 1110.

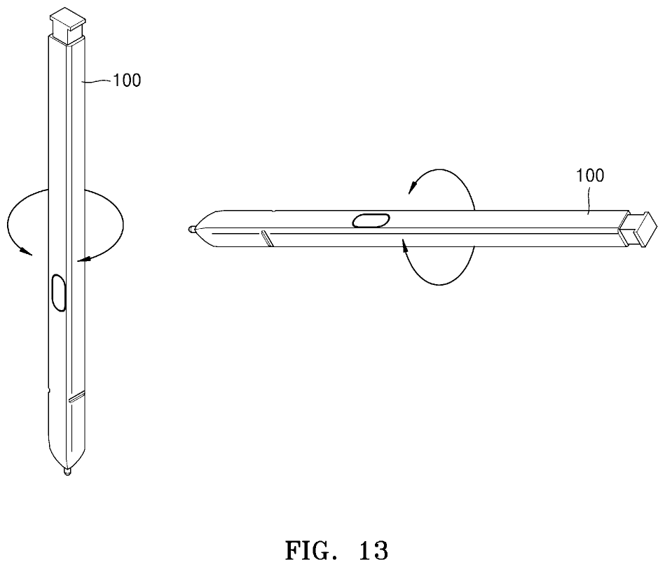

FIG. 13 is a diagram illustrating an example user input method of an electronic pen, according to various embodiments.

Referring to FIG. 13, a method of determining an orientation of the electronic pen 100 and receiving a user input according to the orientation of the electronic pen 100 is illustrated. According to an embodiment of the disclosure, the electronic device 1000 may determine an orientation of the electronic pen 100, and receive a user input according to the orientation of the electronic pen 100. For example, when the electronic pen 100 is erected perpendicular to the ground, the electronic device 1000 may receive a user input according to a rotational direction of at least a part of the electronic pen 100 or the entire electronic pen 100. For example, while the electronic pen 100 is erected perpendicular to the ground or the electronic pen 100 is placed horizontally with respect to the ground, a user input value of the electronic device 1000 when the at least a part of the electronic pen 100 or the entire electronic pen 100 rotate clockwise may be opposite to that when rotating counter-clockwise. For example, while the electronic pen 100 is erected perpendicular to the ground, when the electronic pen 100 rotates clockwise, a user input of directing an orientation to the right may be received, and when the electronic pen 100 rotates counterclockwise, a user input of directing an orientation to the right may be received as a user input. While the electronic pen 100 is placed horizontally with respect to the ground, when the electronic pen 100 rotates clockwise, a user input of directing an upward orientation may be received, and when the electronic pen 100 rotates counterclockwise, a user input of directing a downward orientation may be received as a user input.

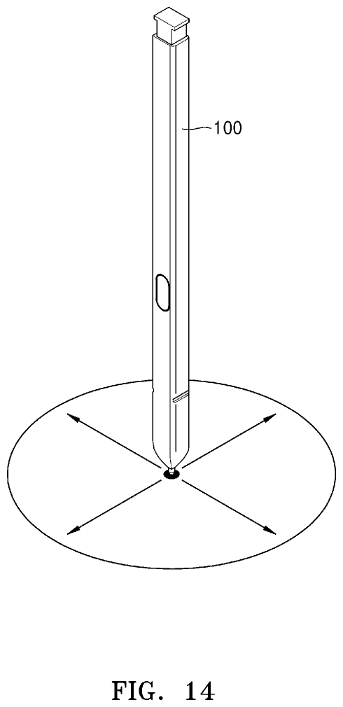

FIG. 14 is a diagram illustrating an example user input method of an electronic pen, according to various embodiments.

Referring to FIG. 14, according to an embodiment of the disclosure, a method is illustrated, in which the electronic device 1000 receives a third user input of selecting a point on a screen displayed to a user, and while receiving the third user input, the electronic device 1000 receives a fourth user input of moving the electronic pen 100. According to an embodiment of the disclosure, the electronic device 1000 may receive a touch input of the electronic pen 100 to a point displayed on a touch screen of the electronic device 1000, that is, a third user input. The electronic device 1000 may receive the fourth user input by detecting movement of the electronic pen 100. However, the third user input and the fourth user input are not limited to the above-described user input methods, but may include various user inputs.

According to an embodiment of the disclosure, the electronic device 1000 that has received a third user input and a fourth user input may execute a preset operation. For example, the electronic device 1000 may execute a preset operation according to the fourth user input, with respect to the point selected via the third user input. For example, according to the fourth user input, the electronic device 1000 may move at least a portion of a screen displayed to a user or the entire screen, with respect to the point selected via the third user input. For example, the electronic device 1000 may select a point on a displayed screen, via a third user input of selecting a particular point, and may rotate or move at least a portion of the screen displayed to a user or the entire screen, according to a fourth user input of moving the electronic pen 100.

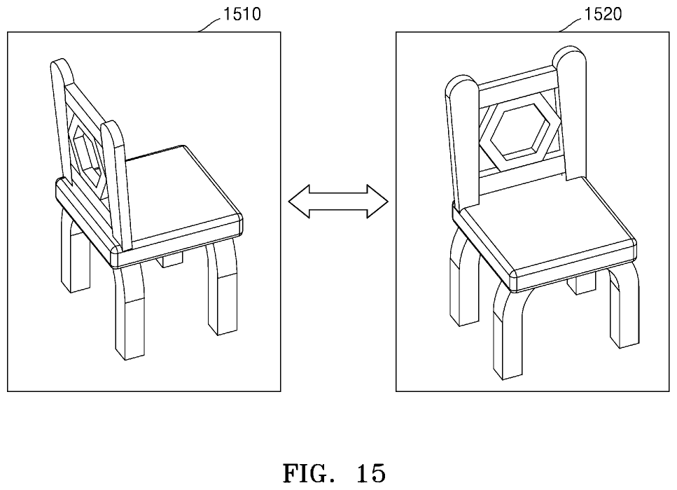

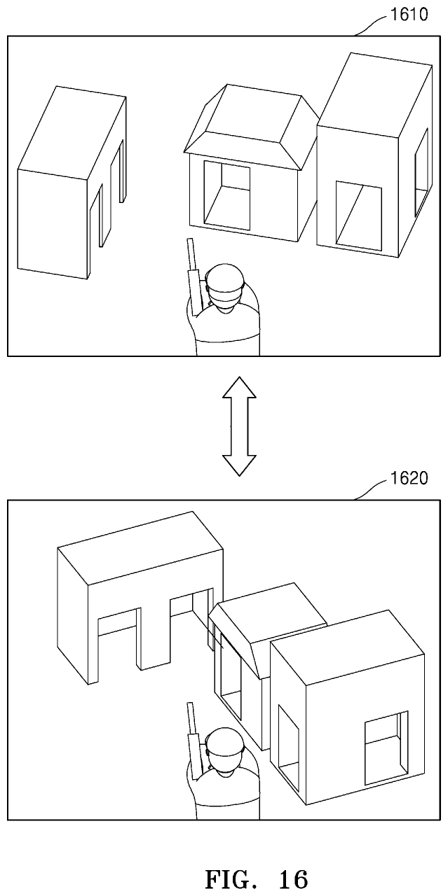

FIG. 15 is a diagram illustrating an example operation of an electronic device based on a user input of an electronic pen, according to various embodiments.

According to an embodiment of the disclosure, the electronic device 1000 may change a viewpoint of a user on a screen displayed to the user, according to a user input. For example, when receiving a user input via the electronic pen 100, the electronic device 1000 may change a viewpoint of a user on a screen displayed to the user, clockwise or counter-clockwise.

Referring to FIG. 15, an operation of the electronic device 1000 according to a user input is illustrated. A first screen 1510 is a screen displayed to a user before a user input, and a second screen 1520 is a screen displayed to the user after the user input. The electronic device 1000 may receive a user input via the electronic pen 100 while the first screen 1510 is being displayed. Here, the electronic device 1000 may receive, from the electronic pen 100, a first user input via at least one operation of rotation of at least a part of the electronic pen 100 or the entire electronic pen 100 or a touch input to a touch pad.

When the electronic device 1000 receives a user input via the electronic pen 100, for example, a first user input, the electronic device 1000 may display the second screen 1520 to a user according to the first user input. The second screen 1520 is a screen where a viewpoint of a user is changed from the first screen 1510. According to an embodiment of the disclosure, while displaying the first screen 1510, that is, while displaying a chair from a first viewpoint, the electronic device 1000 may display the second screen 1520, that is, the chair from a second viewpoint according to a user input. As described above, the electronic device 1000 may change a viewpoint displayed to a user. For example, a viewpoint of a user on a screen displayed to the user may be rotated clockwise or counter-clockwise. According to an embodiment of the disclosure, the electronic device 1000 may display not only a screen before and after a user input, but also display a process of a change of a viewpoint being displayed to a user, according to the user input. For example, in FIG. 15, rotation of a viewpoint from which a user views a chair may be displayed according to a user input.

Furthermore, according to an embodiment of the disclosure, a change of a user's viewpoint does not necessarily have to occur three-dimensionally but may also occur two-dimensionally. For example, when a planar quadrangle is displayed, an orientation of the planar quadrangle being displayed to a user may be rotated according to a user input. For example, the planar quadrangle may be displayed by rotating an orientation of the planar quadrangle being displayed to a user may be rotated by 45 degrees, 90 degrees, or the like. An orientation of a screen being displayed to a user itself may be rotated.

While the change of a viewpoint of a user on a screen displayed to the user according to a user input, using the electronic device 1000, has been described above, the disclosure is not limited thereto, and an object itself on a screen displayed to a user may also be rotated according to a user input. For example, instead of rotating a viewpoint from which a user views the chair according to a user input in FIG. 15, the chair itself may be rotated.

FIG. 16 is a diagram illustrating an example operation of an electronic device based on a user input of an electronic pen, according to various embodiments.

Referring to FIG. 16, while displaying a first screen 1610, that is, a screen from a viewpoint of a character in a First-Person Shooting (FPS) game, the electronic device 1000 may display a second screen 1620, that is, a screen from a rotated or changed viewpoint of the character, according to a user input via the electronic pen 100. For example, a viewpoint of a character in a game may be rotated clockwise or counter-clockwise. According to an embodiment of the disclosure, the electronic device 1000 may display not only a screen before and after a user input, but also display a process of a change of a viewpoint being displayed to a user, according to the user input. For example, in FIG. 16, rotation of a viewpoint of a character according to a user input may be displayed.

In FIG. 15, the electronic device 1000 changes a viewpoint displayed to a user, that is, a user's viewpoint, whereas in FIG. 16, the electronic device 1000 changes a viewpoint of a character in a screen.

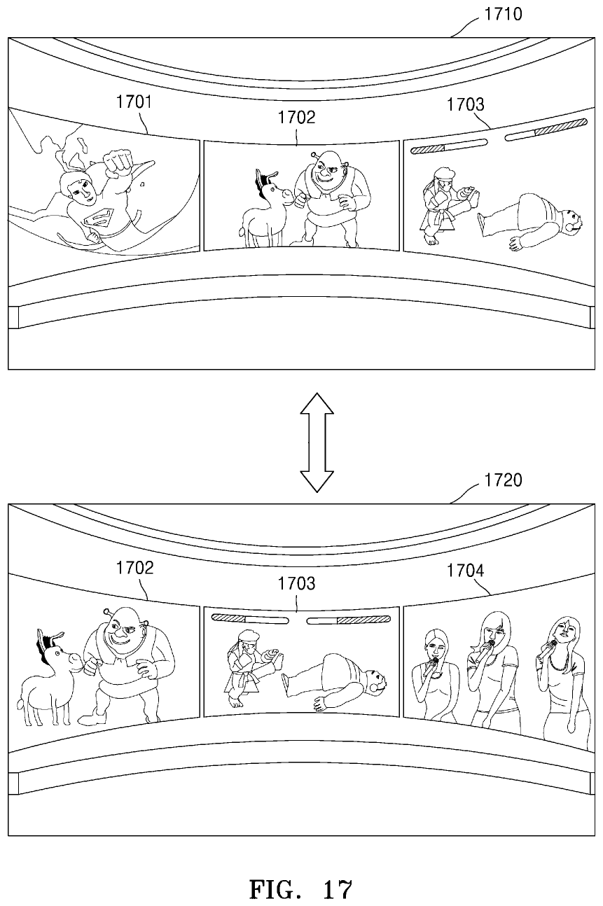

FIG. 17 is a diagram illustrating an example operation of an electronic device based on a user input of an electronic pen, according to various embodiments.

Referring to FIG. 17, while displaying a first screen 1710, that is, a selecting screen in a virtual reality (VR) screen, the electronic device 1000 may display a second screen 1720, that is, a changed selecting screen, according to a user input via the electronic pen 100. For example, a selecting screen may be rotated clockwise or counter-clockwise. In the first screen 1710, first content 1701, second content 1702, and third content 1703 are sequentially displayed. When receiving a user input while displaying the first screen 1710, the selecting screen may be rotated counter-clockwise such that the first content 1701 displayed on a leftmost portion exits through the left boundary of the selecting screen and is no longer displayed, and fourth content 1704 positioned outside the right boundary of the selecting screen enters into the selecting screen to be displayed. Thus, as shown in the second screen 1720, the second content 1702, the third content 1703, and the fourth content 1704 are sequentially displayed.

According to an embodiment of the disclosure, the electronic device 1000 may display not only a screen before and after a user input, but also display a process of a change of a screen being displayed to a user, according to the user input. For example, the electronic device 1000 may display the process of change of the selection screen in FIG. 17.

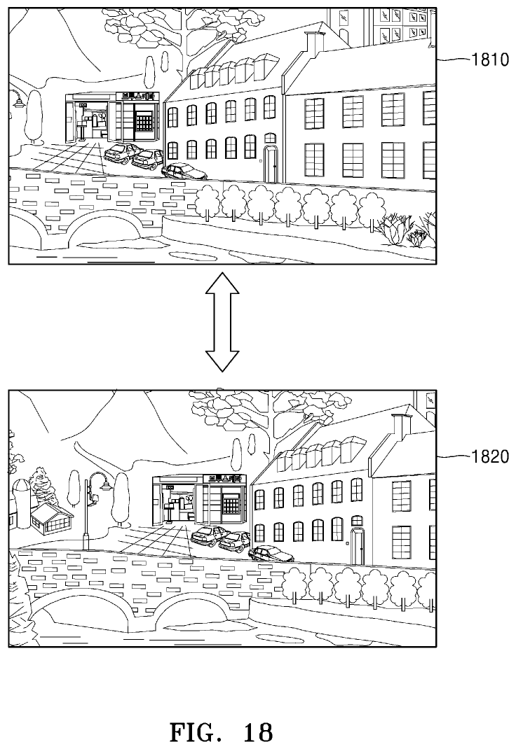

FIG. 18 is a diagram illustrating an example operation of an electronic device based on a user input of an electronic pen, according to various embodiments.

Referring to FIG. 18, while displaying a first screen 1810, the electronic device 1000 may display a second screen 1820, that is, a moved screen, according to a user input via the electronic pen 100. For example, a screen may be moved to the left, to the right, upwards, or downwards. The first screen 1810 is a screen displaying content having a larger size than a screen size, for example, an image or a video. A user may move a portion not displayed on the screen, into the screen, via a user input. That is, the electronic device 1000 may display the second screen 1820 to a user.

Above, it is described that while the first screen 1810 is being displayed, when the electronic device 1000 receives a user input via the electronic pen 100, the electronic device 1000 displays the second screen 1820 to a user according to the user input. However, the disclosure is not limited thereto, and the first screen 1810 may also be displayed by receiving an opposite user input to the above user input while displaying the second screen 1820 to a user.

According to an embodiment of the disclosure, the electronic device 1000 may display not only a screen before and after a user input, but also display a process of a change of a screen being displayed to a user, according to the user input. For example, the electronic device 1000 may display a movement of a screen being displayed in FIG. 18.

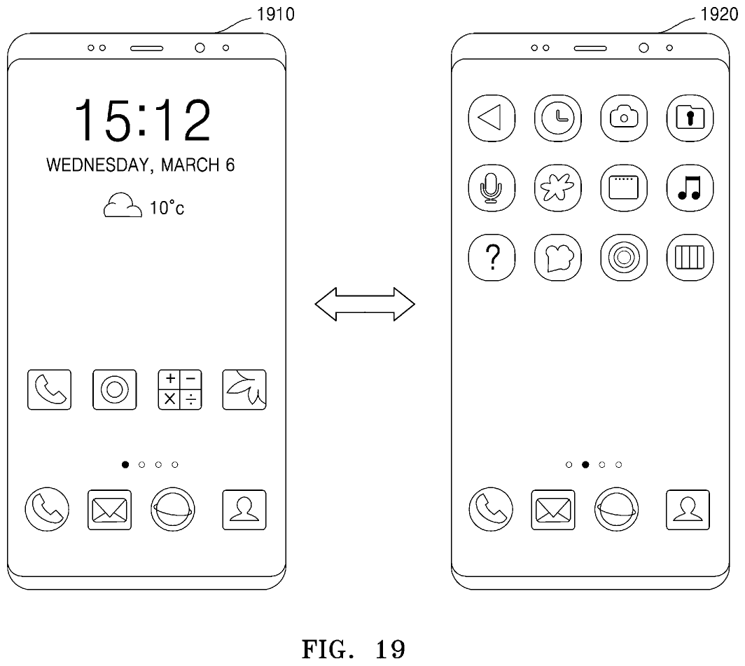

FIG. 19 is a diagram illustrating an example operation of an electronic device based on a user input of an electronic pen, according to various embodiments.

Referring to FIG. 19, while displaying a first screen 1910, the electronic device 1000 may display a second screen 1920, that is, another page or screen, according to a user input via the electronic pen 100. For example, the electronic device 1000 may display a page or screen on the left or right to a currently displayed screen. The first screen 1910 is a screen displaying a home screen of a smartphone. Another page displaying an application icon, a screen provided according to a function of the smartphone, a screen according to a user setting, or the like may be on the right or left to the home screen of the smartphone. A user may move a page or screen that is not displayed on a current screen, into a visible screen, via a user input. That is, the electronic device 1000 may display the second screen 1920 to a user.

According to an embodiment of the disclosure, the electronic device 1000 may display not only a screen before and after a user input, but also display a process of a change of a screen being displayed to a user, according to the user input. For example, the electronic device 1000 may display a movement of a page being displayed in FIG. 19.

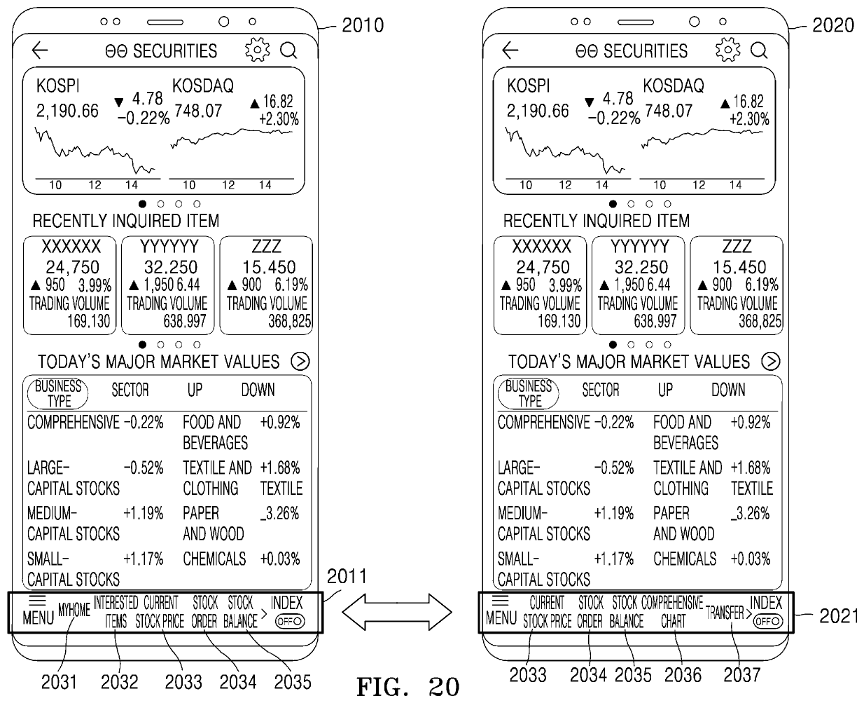

FIG. 20 is a diagram illustrating an example operation of an electronic device based on a user input of an electronic pen, according to various embodiments.

Referring to FIG. 20, the electronic device 1000 may display a screen on which a portion of a currently displayed screen is changed according to a user input. For example, while displaying a first screen 2010, that is, an area 2011 displaying selection menus 2031, 2032, 2033, . . . , 2035 in a screen of a home trading system (HTS), the electronic device 1000 may display a second screen 2020, that is, an area 2021 displaying changed selection menus 2033, 2034, 2035, . . . , 2037, according to a user input via the electronic pen 100.

A user may display menus that are currently not displayed in the areas 2011 and 2021 displaying selection menus, to the areas 2011 and 2021 displaying selections menus, via a user input. In FIG. 20, in the area 2011 displaying selection menus, menus such as a MY home 2031, an item of interest 2032, a current stock price 2033, a stock order 2034, and a stock balance 2035 are sequentially displayed. While displaying the first screen 2010, when a user input is received, the selection menus are moved to the left, and accordingly, the MY home 2031 and the item of interest 2032 which are displayed on the left deviate out of the area 2021 displaying selection menus and thus are not displayed, and a comprehensive chart 2036 and a transfer menu 2037 that are located outside on the right to the area 2011 displaying selection menus enter the area 2021 to be displayed. Thus, as in the second screen 2020, the current stock price 2033, the stock order 2034, the stock balance 2035, the comprehensive chart 2036, and the transfer menu 2037 are sequentially displayed.

According to an embodiment of the disclosure, the electronic device 1000 may display not only a screen before and after a user input, but also display a process of a change of selection menus being displayed to a user, according to the user input. For example, the electronic device 1000 may display a movement of the selection menus in FIG. 20.

While FIG. 19 displays that the electronic device 1000 changes an entire screen displayed to a user, in FIG. 20, the electronic device 1000 changes a portion of a screen displayed to a user is illustrated.

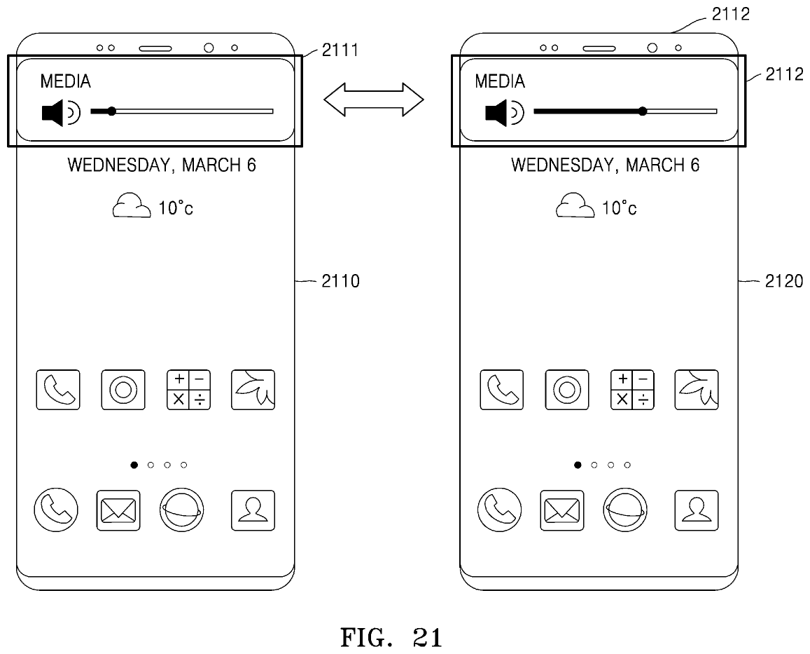

FIG. 21 is a diagram illustrating an example operation of an electronic device based on a user input of an electronic pen, according to various embodiments.

According to an embodiment of the disclosure, the electronic device 1000 may increase or reduce a preset value according to a user input. For example, when receiving a user input via the electronic pen 100, the electronic device 1000 may increase or reduce a setting value on a screen displayed to a user.

Referring to FIG. 21, an operation of the electronic device 1000 according to a user input is illustrated. A first screen 2110 is a screen displayed to a user before a user input, and a second screen 2120 is a screen displayed to the user after the user input. While displaying the first screen 2110, the electronic device 1000 may receive a user input via the electronic pen 100. Here, the electronic device 1000 may receive, from the electronic pen 100, a first user input via at least one operation of rotation of at least a part of the electronic pen 100 or the entire electronic pen 100 or a touch input to a touch pad.

When the electronic device 1000 receives a user input via the electronic pen 100, for example, a first user input, the electronic device 1000 may increase or reduce a preset value according to the first user input. The second screen 2120 is a screen on which a setting value in the first screen 2110 is increased. According to an embodiment of the disclosure, while displaying the first screen 2110, that is, while displaying an area 2111 for changing a media volume value, the electronic device 1000 may change a media volume value according to a user input. The second screen 2120 displays a screen displaying that a media volume value is increased in an area 2112 for changing a media volume value. According to an embodiment of the disclosure, the electronic device 1000 may display not only a screen before and after a user input, but also display a process of a change of a viewpoint being displayed to a user, according to the user input. For example, in FIG. 21, a process of an increase in a media volume value according to a user input may be displayed.

According to an embodiment of the disclosure, the electronic device 1000 may quickly increase or reduce a preset value or increase the amount by which the preset value is increased or decreased, according to a user input. For example, the electronic device 1000 may quickly increase a media volume value from 1 to 10 according to a user input. Also, when increasing the media volume value from 1 to 10, the electronic device 1000 may increase the media volume value by 1 or by 2, 3, or more, according to a user input.

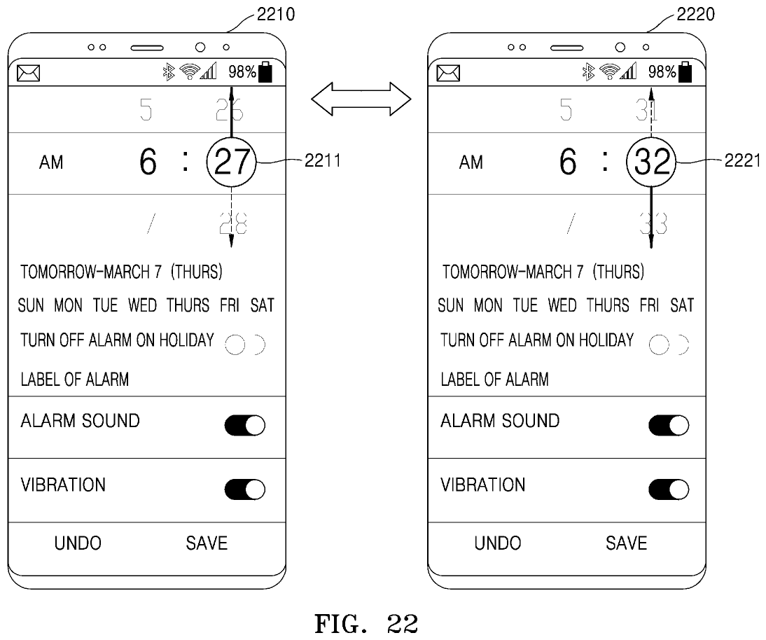

FIG. 22 is a diagram illustrating an example operation of an electronic device based on a user input of an electronic pen, according to various embodiments.

Referring to FIG. 22, while displaying a first screen 2210, the electronic device 1000 may increase or reduce a preset value upon receiving a user input via the electronic pen 100, for example, a first user input. A second screen 2220 is a screen displaying that a setting value in the first screen 2210 is increased. According to an embodiment of the disclosure, while displaying the first screen 2210, that is, while displaying an area 2211 for changing an alarm time, the electronic device 1000 may change an alarm time according to a user input. The second screen 2220 displays a screen displaying that an alarm time is changed in an area 2221 for changing a media alarm time. According to an embodiment of the disclosure, the electronic device 1000 may display not only a screen before and after a user input, but also display a process of a change of a viewpoint being displayed to a user, according to the user input. For example, in FIG. 22, a change of an alarm time according to a user input may be displayed.

According to an embodiment of the disclosure, the electronic device 1000 may quickly increase or reduce a preset value or increase the amount by which the preset value is increased or decreased, according to a user input. For example, the electronic device 1000 may quickly increase an alarm time from 10 minutes to 40 minutes according to a user input. In addition, when increasing the alarm time from 10 minutes to 40 minutes, the electronic device 1000 may change a time interval whereby the alarm time is increased, according to a user input. For example, the electronic device 1000 may increase a time interval by one minute, five minutes, ten minutes, or longer, according to a user input.

The operation of the electronic device 1000 based on a user input of the electronic pen 100 is described above. In addition to the operation of the electronic device 1000 described above, according to an embodiment of the disclosure, the electronic device 1000 may receive a second user input for selecting at least one of an area, field, task, or application for executing a preset operation. For example, the electronic device 1000 may receive a touch input of the electronic pen 100 to an area, a field, or the like, displayed on a touch screen of the electronic device 1000, that is, a second user input. However, the second user input is not limited to a touch input, but may include various user inputs. According to an embodiment of the disclosure, the electronic device 1000 that has received a second user input may perform a preset operation with respect to at least one of an area, a field, a task, or an application selected according to the second user input. For example, when a partial area of a displayed screen is selected via the second user input, a preset operation may be performed on that area.

For example, to rotate the content 1701, 1702, and 1703 on the first screen 1710 of FIG. 17, an area displaying the content 1701, 1702, and 1703 may be selected via a second user input. In addition, to move menus that are currently not displayed in the areas 2011, 2021 displaying selection menus on the first screen 2010 of FIG. 20, into the areas 2011 and 2021 displaying selection menus, the area 2011 displaying selection menus may be selected via a second user input. Furthermore, to select a value to be changed in FIGS. 21 and 22, the areas 2111 and 2211, in which values to be changed are displayed in the first screens 2110 and 2210, may be selected via a second user input.

The operations of the electronic device 1000 described above are merely an example of the disclosure, and the electronic device 1000 may perform various operations based on a user input of the electronic pen 100, without being limited to the above-described operations. In addition, it is described above that while the electronic device 1000 is displaying the first screen 2010, when the electronic device 1000 receives a user input via the electronic pen 100, the electronic device 1000 displays the second screen 2020 to a user according to the user input. However, the disclosure is not limited thereto, and the electronic device 1000 may also display the first screen 2010 by receiving an opposite user input to the above user input while displaying the second screen 2020 to a user.

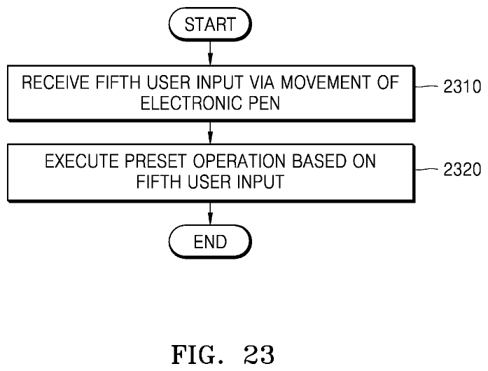

FIG. 23 is a flowchart illustrating an example method of operating an electronic device executing an operation based on a user input via an electronic pen, according to various embodiments.

In operation 2310, the electronic device 1000 may receive a fifth user input via movement of the electronic pen 100. According to an embodiment of the disclosure, a movement of the electronic pen 100 may be made by physical control by a user, and a user input value may vary according to movement of the electronic pen 100. For example, the electronic device 1000 may receive, as a user input, an image drawn by a user using the electronic pen 100. A movement of the electronic pen 100 may include an interaction with the electronic device 1000, for example, a touch on a touch screen of the electronic device 1000 or a movement made regardless of the electronic device 1000. For example, when a user draws an image on a touch screen of the electronic device 1000 or in the air using the electronic pen 100, the electronic device 1000 may detect a movement of the electronic pen 100 and receive the same as a user input.

According to an embodiment of the disclosure, the electronic device 1000 may receive a fifth user input based on at least one of an orientation, a direction, a movement speed, or a movement period of the electronic pen 100, or a number of rotations of a rolling ball tip.

In operation 2320, the electronic device 1000 may execute a preset operation based on the fifth user input. According to an embodiment of the disclosure, the electronic device 1000 may render a two-dimensional or three-dimensional image according to a movement of the electronic pen 100. For example, the electronic device 1000 may render an image drawn according to a movement of the electronic pen 100. For example, when a user draws an image on a touch screen of the electronic device 1000 or in the air using the electronic pen 100, the electronic device 1000 may render and display an image corresponding to the above image.

According to an embodiment of the disclosure, the electronic device 1000 may measure a movement distance of the electronic pen 100 according to a movement of the electronic pen 100. For example, the electronic device 1000 may measure a distance that the electronic pen 100 has moved, by detecting a movement of the electronic pen 100. For example, when drawing an image along a straight line or a curve using the electronic pen 100, the electronic device 1000 may detect this as a movement of the electronic pen 100 to measure a distance of the straight line or the curve.

According to an embodiment of the disclosure, the electronic device 1000 may receive a sixth user input. The electronic device 1000 may undo execution of a preset operation based on a sixth user input. For example, with respect to an operation according to a previous user input desired to be undone or a result of the operation desired to be undone, a user may undo the operation or the result of the operation via a user input, that is, a sixth user input. According to an embodiment of the disclosure, when a sixth user input is repeatedly input, an operation according to a previous user input or a result of the operation may be undone in a reverse order to the operation according to the previous user input or the result of the operation. In addition, according to an embodiment of the disclosure, when receiving a sixth user input regarding a particular operation or a result of the operation, the electronic device 1000 may undo the operation or the result of the operation.

According to an embodiment of the disclosure, a sixth user input may include a user input via the electronic pen 100, a user input regarding the electronic device 1000, or the like. A user input via the electronic pen 100 may include, for example, a user input via a physical button or a touch button of the electronic pen 100, a user input via a set movement of the electronic pen 100, for example, an operation of shaking the electronic pen 100, or the like. In addition, a user input regarding the electronic device 1000 may include a user input via a physical button, a touch button, or a touch screen of the electronic device 1000, a user input via a set movement of the electronic device 1000, or the like.

Furthermore, according to an embodiment of the disclosure, the electronic device 1000 may display an image for calibration of the electronic pen 100, receive a seventh user input regarding the image via the electronic pen 100, and transmit a result regarding the seventh user input to the electronic pen 100. According to an embodiment of the disclosure, an image for calibration of the electronic pen 100 may be previously stored in the electronic device 1000 or obtained from an external device according to necessity. In addition, the electronic device 1000 may previously store a setting value corresponding to an image for calibration or obtain the setting value from an external device. The electronic device 1000 may receive a seventh user input regarding an image for calibration and compare the seventh user input with a setting value corresponding to the seventh user input and transmit a comparison result to the electronic pen 100. Here, the result transmitted to the electronic pen 100 may include data for calibration of the electronic pen 100. According to an embodiment of the disclosure, a plurality of images for calibration may be present, and there may be an image for adjusting a particular value.

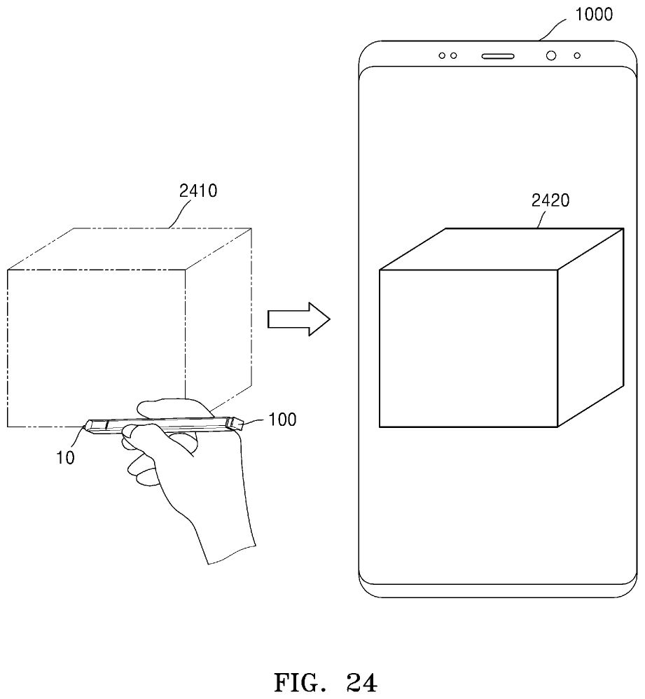

FIG. 24 is a diagram illustrating an example user input method of an electronic pen, according to various embodiments.

Referring to FIG. 24, a method of receiving a user input via movement of the electronic pen 100 is illustrated. The electronic device 1000 may receive, from the electronic pen 100, a user input via movement of the electronic pen 100. The electronic device 1000 may receive, from the electronic pen 100, a user input via movement of the tip 10 of the electronic pen 100. In FIG. 24, when a user holds the electronic pen 100 and draws a three-dimensional image 2410 using the tip 10 of the electronic pen 100, the electronic device 1000 may receive, from the electronic pen 100, a user input via movement of the electronic pen 100, and render and display an image 2420 corresponding to the user input. According to an embodiment of the disclosure, the electronic device 1000 may immediately render an image upon recognizing movement of the electronic pen 100, or may render an image when a looped curve or a figure is completed via movement of the electronic pen 100. For example, as the electronic pen 100 is moved, a line may be immediately marked according to the movement to render and display an image, or when a looped curve or a figure is completed via movement of the electronic pen 100, an image of the completed looped curve or figure may be rendered and displayed.

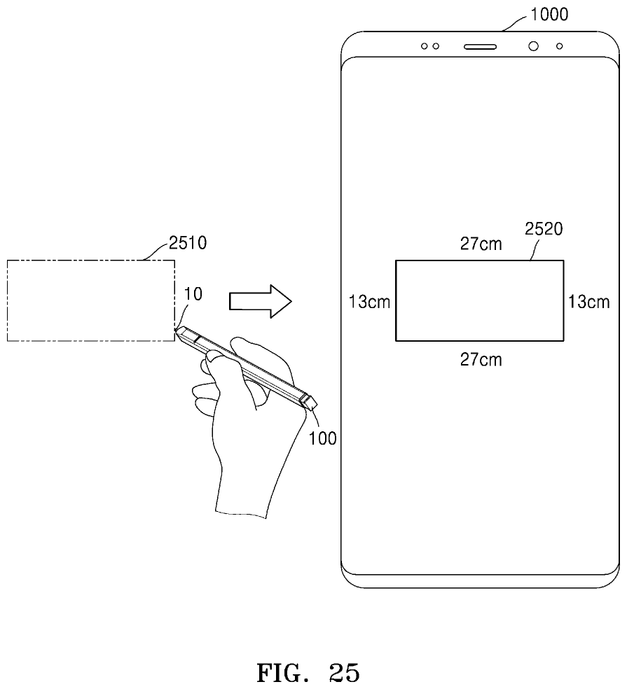

FIG. 25 is a diagram illustrating an example user input method of an electronic pen, according to various embodiments.

Referring to FIG. 25, the electronic device 1000 may receive, from the electronic pen 100, a user input via movement of the electronic pen 100. When a user holds the electronic pen 100 and draws a two-dimensional image 2510 using the tip 10 of the electronic pen 100, the electronic device 1000 may receive, from the electronic pen 100, a user input via movement of the electronic pen 100, and render and display an image 2520 corresponding to the user input. Here, the electronic device 1000 may measure a movement distance of the electronic pen 100 according to movement of the electronic pen 100, for example, according to a movement of the tip 10 of the electronic pen 100. For example, the electronic device 1000 may measure a distance that the electronic pen 100 has moved, by detecting movement of the electronic pen 100. According to an embodiment of the disclosure, the electronic device 1000 may measure a distance moved so far according to movement of the electronic pen 100 and dynamically display the distance, or when the movement of the electronic pen 100 stops, the electronic device 1000 may measure and display a total distance moved. That is, as the electronic pen 100 is moved, a line may be immediately marked according to the movement and a length of the line may be dynamically displayed, or when a looped curve or a figure is completed via movement of the electronic pen 100, lengths of lines may be displayed in an image of the completed looped curve or figure.

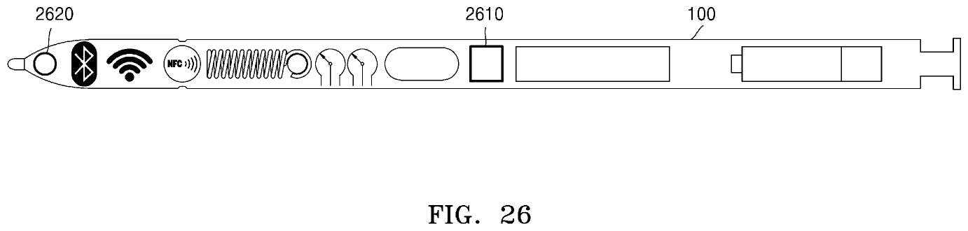

FIG. 26 is a diagram illustrating an example structure of an electronic pen for supporting a user input method of the electronic pen, according to various embodiments.

Referring to FIG. 26, to receive a user input via movement of the electronic pen 100, the electronic pen 100 may include devices 2610 and 2620 for detecting movement of the electronic pen 100 in addition to the at least a part of the electronic pen 100 described with reference to FIGS. 2 and 3.

According to an embodiment of the disclosure, the first device 2610 for detecting movement of the electronic pen 100 may include a magnetic sensor, an acceleration sensor, a gyroscopic sensor, or the like. However, the first device 2610 for detecting movement of the electronic pen 100 is not limited thereto, and may include various sensors and devices for detecting movement of the electronic pen 100. The first device 2610 for detecting movement of the electronic pen 100 as described above may be mounted in the main body 20 of the electronic pen 100.

According to an embodiment of the disclosure, the second device 2620 for detecting movement of the electronic pen 100 may include a rolling ball tip. The rolling ball tip is a device for detecting movement of the electronic pen 100 via rotation of a ball, and may include a rotatable ball and a sensor and device for detecting a rotational speed, a rotational direction, or the like, of the ball. The rolling ball tip may be positioned at the tip 10 of the electronic pen 100. According to an embodiment of the disclosure, when a user uses the electronic pen 100, the ball of the rolling ball tip may rotate, and movement of the electronic pen 100 may be detected by detecting a rotational speed, a rotational direction, or the like of the rotating ball.

According to an embodiment of the disclosure, the electronic pen 100 may support a method of receiving a user input via rotation of the electronic pen 100 described with reference to FIG. 25, using the devices 2610 and 2620 for detecting movement of the electronic pen 100.

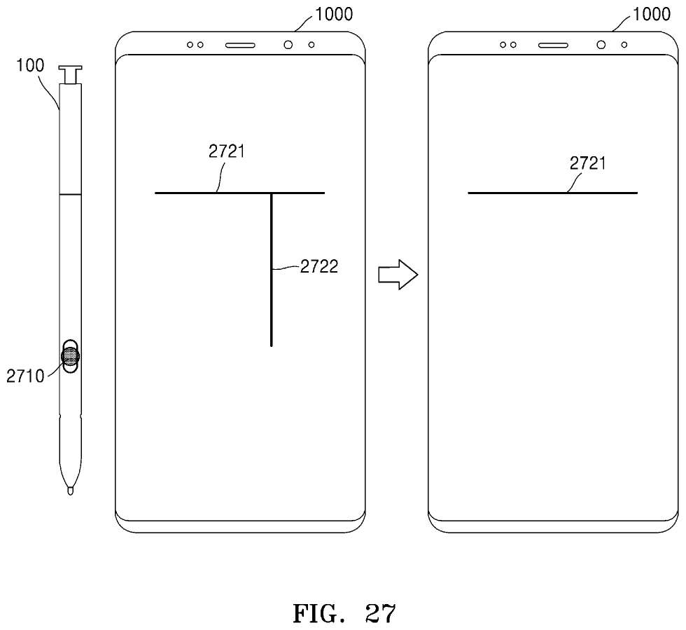

FIG. 27 is a diagram illustrating an example method of undoing a user input of an electronic pen, according to various embodiments.

According to an embodiment of the disclosure, the electronic device 1000 may receive a sixth user input, and may undo execution of a preset operation based on the sixth user input. For example, with respect to an operation according to a previous user input, that is, according to a fifth user input, or a result of the operation, wherein the operation is wished to be undone, a user may undo the operation or the result of the operation via a sixth user input. According to an embodiment of the disclosure, a sixth user input may include a user input via the electronic pen 100, a user input regarding the electronic device 1000, or the like.

Referring to FIG. 27, a method of undoing a user input of the electronic pen 100 is illustrated. The electronic device 1000 is sequentially displaying a line 1 (2721) and a line 2 (2722) by sequentially receiving two user inputs previously. The electronic device 1000 may receive a user input that is a sixth user input via the electronic pen 100. The sixth user input may include a button input 2710 via a button of the electronic pen 100, that is, a physical button or a touch button of the electronic pen 100. Upon receiving the sixth user input, the electronic device 1000 may undo an operation according to a previous user input or a result of the operation. In FIG. 27, the electronic device 1000 may delete the line 2 (2722) which is a result of an operation according to an immediately preceding user input.

According to an embodiment of the disclosure, when a sixth user input is repeatedly input, an operation according to a previous user input or a result of the operation may be undone in a reverse order to the operation according to the previous user input or the result of the operation. In FIG. 27, upon receiving a button input 2710 once, the electronic device 1000 may delete the line 2 (2722) which is a result of the operation of the immediately preceding user input. When the electronic device 1000 receives the button input 2710 one more time, the electronic device 1000 may delete the line 1 (2721) which is a result of the operation according to a user input before the immediately preceding user input.

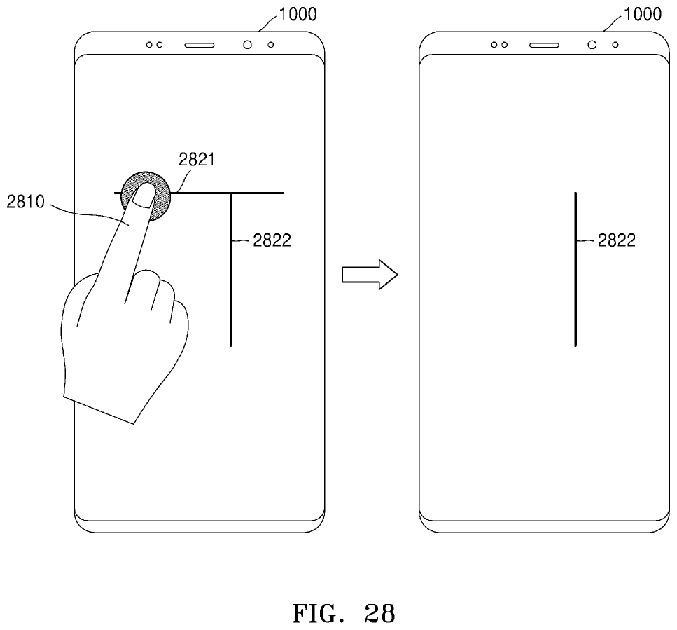

FIG. 28 is a diagram illustrating an example method of undoing a user input of an electronic pen, according to various embodiments.

Referring to FIG. 28, a method of undoing a user input of the electronic pen 100 is illustrated. The electronic device 1000 is sequentially displaying a line 1 (2821) and a line 2 (2822) by sequentially receiving two user inputs previously. The electronic device 1000 may receive a sixth user input that is a user input regarding the electronic device 1000. Here, the sixth user input may include a user input using a physical button, a touch button, or a touch screen of the electronic device 1000, and a touch input 2810 to a touch screen is the sixth user input in FIG. 28. In FIG. 28, while the touch input 2810 is made by the body part of a user, that is, finger, but the electronic device 1000 may also receive the touch input 2810 using the electronic pen 100. Upon receiving the sixth user input, the electronic device 1000 may undo an operation according to a previous user input or a result of the operation. In FIG. 28, the electronic device 1000 may delete the line 2 (2822) which is a result of an operation according to an immediately preceding user input.

According to an embodiment of the disclosure, when receiving a sixth user input regarding a particular operation or a result of the operation, the electronic device 1000 may undo the operation or the result of the operation. While the electronic device 1000 sequentially receives two user inputs previously to sequentially display the line 1 (2821) and the line 2 (2822), regardless of an order of operations or results of the operations, the touch input 2810 regarding the line 1 (2821) may be received and the line 1 (2821), which is a result of an operation according to a user input that is made earlier, may be deleted.

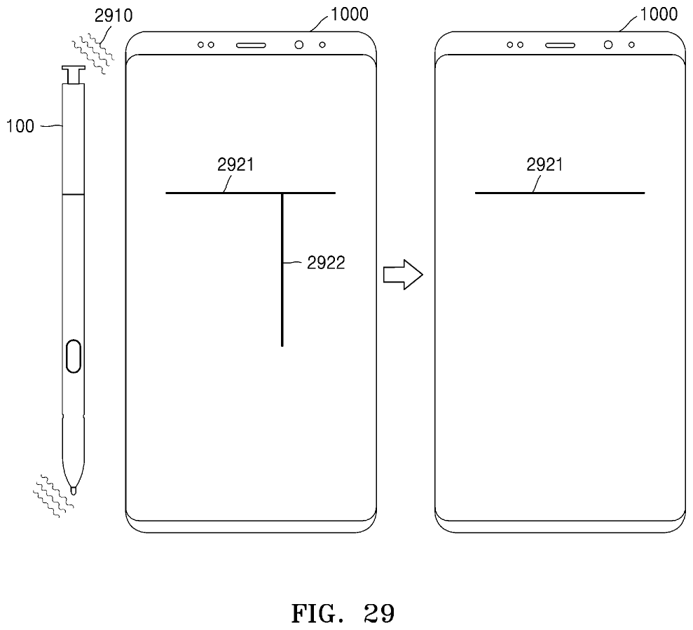

FIG. 29 is a diagram illustrating an example method of undoing a user input of an electronic pen, according to various embodiments.

Referring to FIG. 29, a method of undoing a user input of the electronic pen 100 is illustrated. The electronic device 1000 is sequentially displaying a line 1 (2921) and a line 2 (2922) by sequentially receiving two user inputs previously. The electronic device 1000 may receive a sixth user input that is a user input regarding the electronic device 1000. Here, the sixth user input may include a user input via a set movement of the electronic device 1000, and in FIG. 29, an operation 2910 of shaking the electronic pen 100 may be the sixth user input. Upon receiving the sixth user input, the electronic device 1000 may undo an operation according to a previous user input or a result of the operation. In FIG. 29, the electronic device 1000 may delete the line 2 (2922) which is a result of an operation according to an immediately preceding user input.

According to an embodiment of the disclosure, when a sixth user input is repeatedly input, an operation according to a previous user input or a result of the operation may be undone in a reverse order to the operation according to the previous user input or the result of the operation. In FIG. 29, upon receiving a user input according to operation 2910 of shaking the electronic pen 100, once, the electronic device 1000 may delete the line 2 (2922) which is a result of the operation of the immediately preceding user input. When the electronic device 1000 receives a user input according to operation 2910 of shaking the electronic pen 100 one more time, the electronic device 1000 may delete the line 1 (2921) which is a result of the operation according to a user input before the immediately preceding user input.

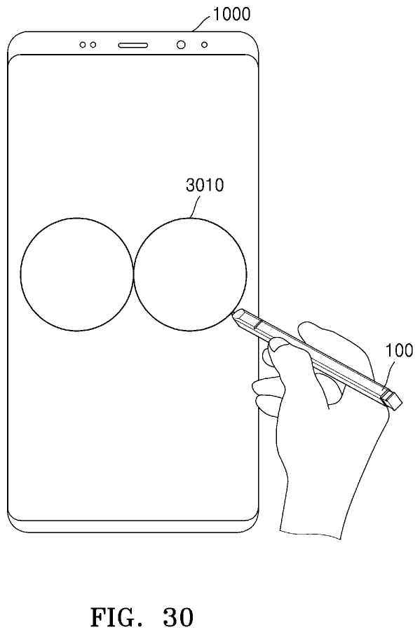

FIG. 30 is a diagram illustrating example calibration of an electronic pen, according to various embodiments.

According to an embodiment of the disclosure, the electronic device 1000 may display an image for calibration of the electronic pen 100, receive a seventh user input regarding the image via the electronic pen 100, and transmit a result regarding the seventh user input to the electronic pen 100. According to an embodiment of the disclosure, an image for calibration of the electronic pen 100 may be previously stored in the electronic device 1000 or obtained from an external device according to necessity. The electronic device 1000 may receive a seventh user input regarding an image for calibration and compare the seventh user input with a setting value corresponding to the seventh user input and transmit a comparison result to the electronic pen 100. Here, the result transmitted to the electronic pen 100 may include data for calibration of the electronic pen 100. According to an embodiment of the disclosure, a plurality of images for calibration may be present, and there may be an image for adjusting a particular value.

Referring to FIG. 30, a method of calibrating the electronic pen 100 according to an embodiment of the disclosure is illustrated. The electronic device 1000 displays an image 3010 for calibration, wherein the image 3010 is previously stored or obtained from an external device. When a user draws the image 3010 for calibration, using the electronic pen 100, the electronic device 1000 may receive, from the electronic pen 100, a seventh user input corresponding to the drawing of the image 3010 for calibration. The electronic device 1000 may compare the seventh user input with a setting value corresponding to the image 3010 for calibration, wherein the image 3010 is previously stored or obtained from an external device. By comparing the seventh user input with the setting value, the electronic device 1000 may generate and transmit data for calibration to the electronic pen 100.

The operating method of the electronic device 1000 of executing an operation based on a user input via the electronic pen 100 is described above. The operations of the electronic device 1000 described above are merely an example embodiment of the disclosure, and the electronic device 1000 may perform various operations based on a user input of the electronic pen 100, without being limited to the above-described operations.

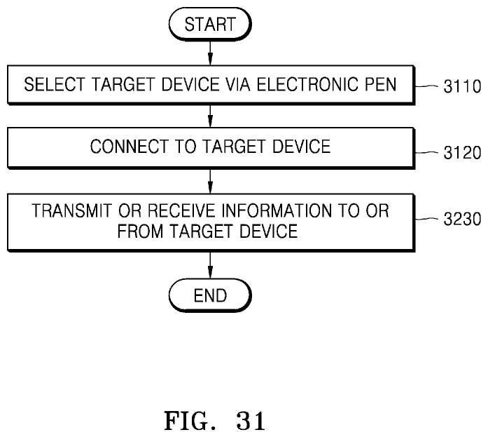

FIG. 31 is a flowchart illustrating an example method of operating an electronic device executing an operation based on a user input via an electronic pen, according to various embodiments.

In operation 3110, the electronic device 1000 may select a target device via the electronic pen 100. As a user points the tip 10 of the electronic pen 100 to a target device to select and inputs a command to select the target device using a user inputter of the electronic pen 100, the electronic device 1000 may select the target device. According to an embodiment of the disclosure, the electronic device 1000 may select a target device by transmitting at least one of an infrared signal or an ultrasound signal to the target device using the electronic pen 100.

In operation 3120, the electronic device 1000 may connect to the target device. In operation 3110, the target device that has detected the infrared signal or the ultrasound signal, or the like, transmitted by the electronic pen 100, may perform a preset operation. For example, the target device may transmit an initial connection message. Here, as the target device has not specified an opposite device to which an initial connection message is to be transmitted, the initial connection message may be a broadcast message. According to an embodiment of the disclosure, the electronic device 1000 may receive an initial connection message transmitted from the target device and perform a connection to the target device based on the initial connection message. In addition, the initial connection message may include a pairing request. By performing pairing, the electronic device 1000 may connect to the target device.

According to an embodiment of the disclosure, the electronic device 1000 may connect to the target device through at least one of Bluetooth, WiFi, WFD, NFC, or UWB.

In operation 3130, the electronic device 1000 may transmit or receive information to or from the target device. According to an embodiment of the disclosure, the electronic device 1000 may transmit or receive at least one of control information or status information of the target device. For example, the electronic device 1000 may receive status information of the target device from the target device, and transmit control information to the target device to control the target device according to the status information.

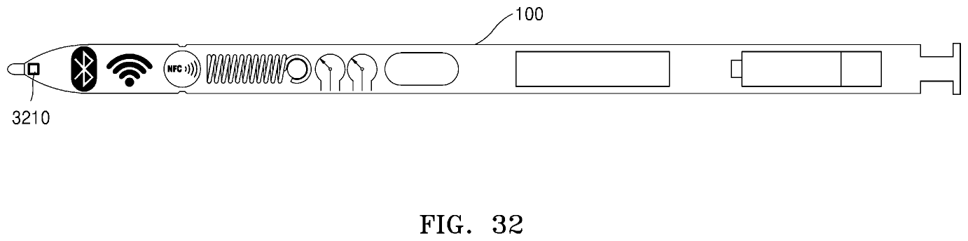

FIG. 32 is a diagram illustrating an example structure of an electronic pen for supporting a user input method of the electronic pen, according to various embodiments.

Referring to FIG. 32, to support a method of selecting, by the electronic device 1000, a target device using the electronic pen 100, the electronic pen 100 may include a device 3210 for transmitting a signal to select a target device in addition to the at least a part of the electronic pen 100 described with reference to FIGS. 2 and 3. According to an embodiment of the disclosure, the electronic pen 100 may include, as the device 3210 for transmitting a signal to select a target device, an IrDA communicator or an ultrasound communicator. As an infrared signal and an ultrasound signal have high linearity, they may be used as signals to select a target device. However, the disclosure is not limited thereto, and the electronic pen 100 may include various sensors and devices for transmitting a signal to select a target device. The device 3210 for transmitting a signal to select a target device as described above may be mounted in the main body 20 of the electronic pen 100. In particular, to support a user pointing a target device using the tip 10 of the electronic pen 100, the device 3210 for transmitting a signal to select a target device may be mounted near the tip 10 of the electronic pen 100.

According to an embodiment of the disclosure, the electronic pen 100 may support a method of selecting, by the electronic device 1000, a target device using the electronic pen 100, described with reference to FIG. 31, using the device 3210 for transmitting a signal to select a target device.

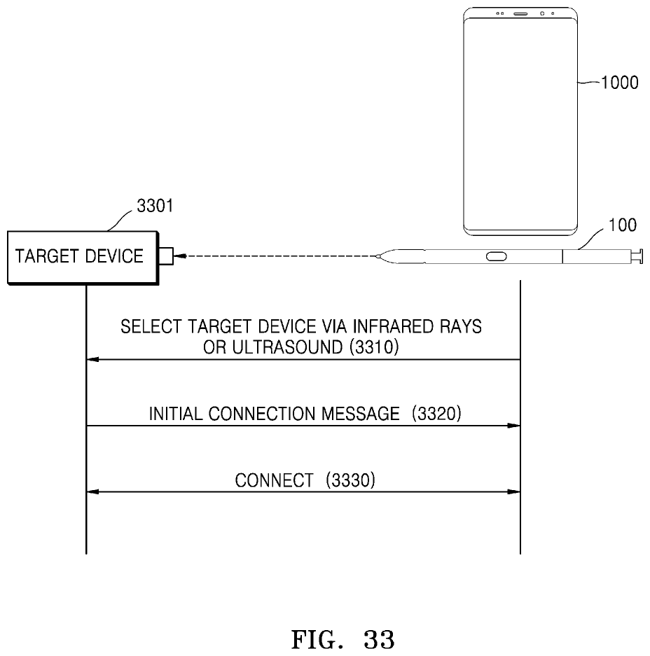

FIG. 33 is a signal flow diagram illustrating an example connection method with respect to a target device, according to various embodiments.

In operation 3310, the electronic device 1000 may select a target device 3301 using the electronic pen 100. According to an embodiment of the disclosure, as a user points the tip 10 of the electronic pen 100 to the target device 3301 to select and inputs a command to select the target device 3301 using a user inputter of the electronic pen 100, the electronic device 1000 may select the target device 3301. According to an embodiment of the disclosure, the electronic device 1000 may select the target device 3301 by transmitting at least one of an infrared signal or an ultrasound signal to the target device 3301 using the electronic pen 100.

In operation 3320, the electronic device 1000 may receive an initial connection message from the target device 3301. The target device 3301 that has detected the infrared signal or the ultrasound signal, or the like, transmitted by the electronic pen 100, may perform a preset operation. For example, the target device 3301 may transmit an initial connection message. Here, as the target device has not specified an opposite device to which an initial connection message is to be transmitted, the initial connection message may be a broadcast message. In addition, according to an embodiment of the disclosure, the initial connection message may include a pairing request.

In operation 3330, the electronic device 1000 may connect to the target device 3301. According to an embodiment of the disclosure, as the electronic device 1000 performs pairing with the target device 3301 according to a pairing request included in the initial connection message, the electronic device 1000 may connect to the target device 3301. According to an embodiment of the disclosure, the electronic device 1000 may connect to the target device 3301 through at least one of Bluetooth, WiFi, WFD, NFC, or UWB.

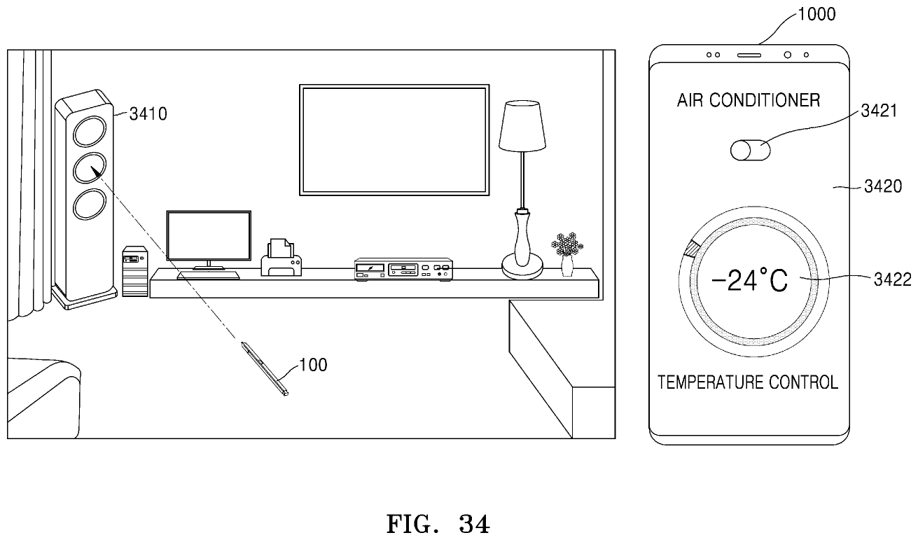

FIG. 34 is a diagram illustrating an example user input method of an electronic pen, according to various embodiments.

According to an embodiment of the disclosure, the electronic device 1000 may select a target device via the electronic pen 100, connect to the target device, and transmit or receive information to or from the target device.

Referring to FIG. 34, as a user points the tip 10 of the electronic pen 100 to a target device to select, e.g., an air conditioner 3410, and inputs a command to select the air conditioner 3410, which is the target device, using a user inputter of the electronic pen 100, the electronic device 1000 may select the air conditioner 3410 as the target device. Here, the electronic pen 100 may select the air conditioner 3410 by transmitting an infrared signal or an ultrasound signal which have high linearity, according to a user input, toward where the air conditioner 3410, which is the target device, is located. The air conditioner 3410 that has detected the infrared signal or the ultrasound signal, or the like, transmitted by the electronic pen 100, may perform a preset operation. That is, the air conditioner 3410 may broadcast an initial connection message including a pairing request. Upon receiving the initial connection message including the pairing request, the electronic device 1000 may perform pairing with the air conditioner 3410 according to the pairing request, thereby connecting to the air conditioner 3410.

The electronic device 1000 may transmit or receive information to or from the air conditioner 3410. In FIG. 34, the electronic device 1000 may display a control screen 3420 of the air conditioner 3410 by receiving, from the air conditioner 3410, information regarding power on/off and information about a set temperature or a current temperature. The control screen 3420 of the air conditioner 3410 may include received information, for example, information 3421 regarding power on/off and information 3422 regarding a set temperature or a current temperature. The electronic device 1000 may receive a user input to transmit control information to the air conditioner 3410. For example, the electronic device 1000 may receive, from a user, a user input of changing a set temperature while the control screen 3420 of the air conditioner 3410 is displayed, to transmit control information corresponding to the user input, to the air conditioner 3410.

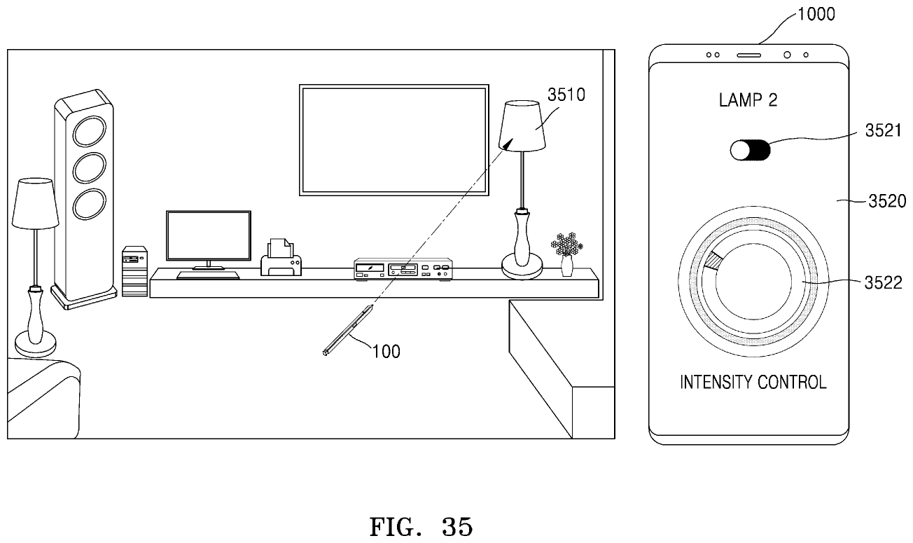

FIG. 35 is a diagram illustrating an example user input method of an electronic pen, according to various embodiments.

Referring to FIG. 35, as a user points the tip 10 of the electronic pen 100 to a target device to select, e.g., a lamp 2 3510, and inputs a command to select the lamp 2 3510, which is the target device, using a user inputter of the electronic pen 100, the electronic device 1000 may select the lamp 2 3510 as the target device. Here, the electronic pen 100 may select the lamp 2 3510 by transmitting an infrared signal or an ultrasound signal which have high linearity, according to a user input, toward where the lamp 2 3510, which is the target device, is located. The lamp 2 3510 that has detected the infrared signal or the ultrasound signal, or the like, transmitted by the electronic pen 100, may perform a preset operation. That is, the lamp 2 3510 may broadcast an initial connection message including a pairing request. Upon receiving the initial connection message including the pairing request, the electronic device 1000 may perform pairing with the lamp 2 3510 according to the pairing request, thereby connecting to the lamp 2 3510.

The electronic device 1000 may transmit or receive information to or from the lamp 2 3510. In FIG. 35, the electronic device 1000 may display a control screen 3520 of the lamp 2 3510 by receiving, from the lamp 2 3510, information regarding power on/off and information about a set intensity of light. The control screen 3520 of the lamp 2 3510 may include received information, for example, information 3521 regarding power on/off and information 3522 regarding a set intensity of light. The electronic device 1000 may receive a user input to transmit control information to the lamp 2 3510. For example, the electronic device 1000 may receive, from a user, a user input of changing a light intensity while the control screen 3520 of the lamp 2 3510 is displayed, to transmit control information corresponding to the user input, to the lamp 2 3510.

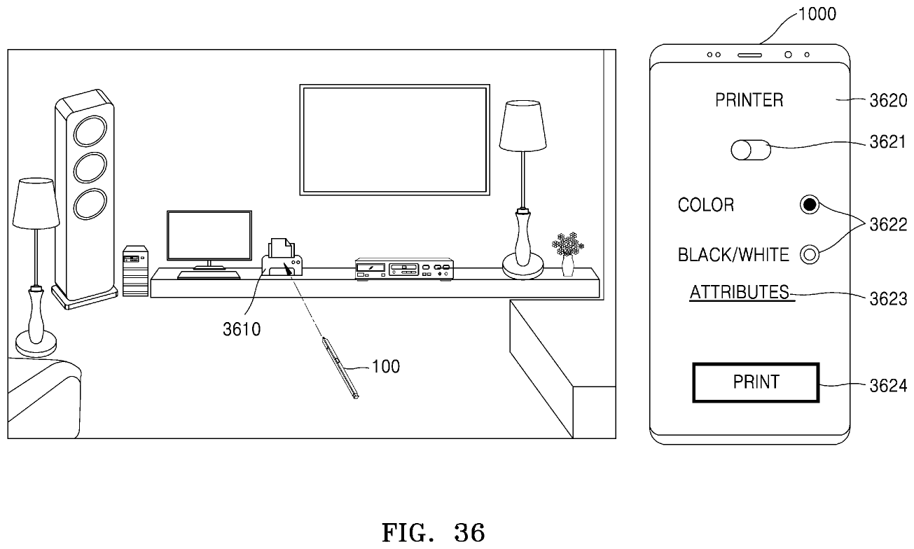

FIG. 36 is a diagram illustrating an example user input method of an electronic pen, according to various embodiments.

Referring to FIG. 36, as a user points the tip 10 of the electronic pen 100 to a target device to select, e.g., a printer 3610, and inputs a command to select the printer 3610, which is the target device, using a user inputter of the electronic pen 100, the electronic device 1000 may select the printer 3610 as the target device. Here, the electronic pen 100 may select the printer 3610 by transmitting an infrared signal or an ultrasound signal which have high linearity, according to a user input, toward where the printer 3610, which is the target device is located. The printer 3610 that has detected the infrared signal or the ultrasound signal, or the like, transmitted by the electronic pen 100, may perform a preset operation. That is, the printer 3610 may broadcast an initial connection message including a pairing request. Upon receiving the initial connection message including the pairing request, the electronic device 1000 may perform pairing with the printer 3610 according to the pairing request, thereby connecting to the printer 3610.

The electronic device 1000 may transmit or receive information to or from the printer 3610. In FIG. 36, the electronic device 1000 may display a control screen 3620 of the printer 3610 by receiving, from the printer 3610, information regarding power on/off, information regarding color/black and white settings, and information about attributes. The control screen 3620 of the printer 3610 may include received information, for example, information 3621 regarding power on/off, information 3622 regarding color/black and white settings, and information 3623 about attributes. Furthermore, the control screen 3620 of the printer 3610 may further include, in addition to the information received from the target device, that is, the printer 3610, items or fields to control the printer 3610. In FIG. 36, the control screen 3620 of the printer 3610 may display a print button or a field 3624 to trigger the printer 3610.

The electronic device 1000 may receive a user input to transmit control information to the printer 3610. For example, the electronic device 1000 may receive, from a user, a user input of changing a setting or attributes or a user input of directing printing while the control screen 3620 of the printer 3610 is displayed, and transmit control information corresponding to the user input, to the printer 3610.

The operating method of the electronic device 1000 of executing an operation based on a user input via the electronic pen 100 is described above. The operations of the electronic device 1000 described above are merely example embodiments of the disclosure, and the electronic device 1000 may perform various operations based on a user input of the electronic pen 100, without being limited to the above-described operations. The target devices described above are merely examples, and without limitation to these target devices, the electronic device 1000 may operate with respect to various target devices, and status information to be received or control information to be transmitted may vary according to target devices.

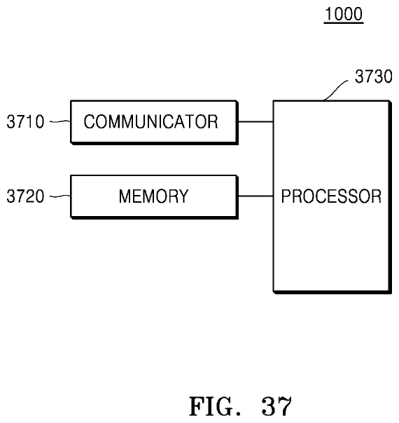

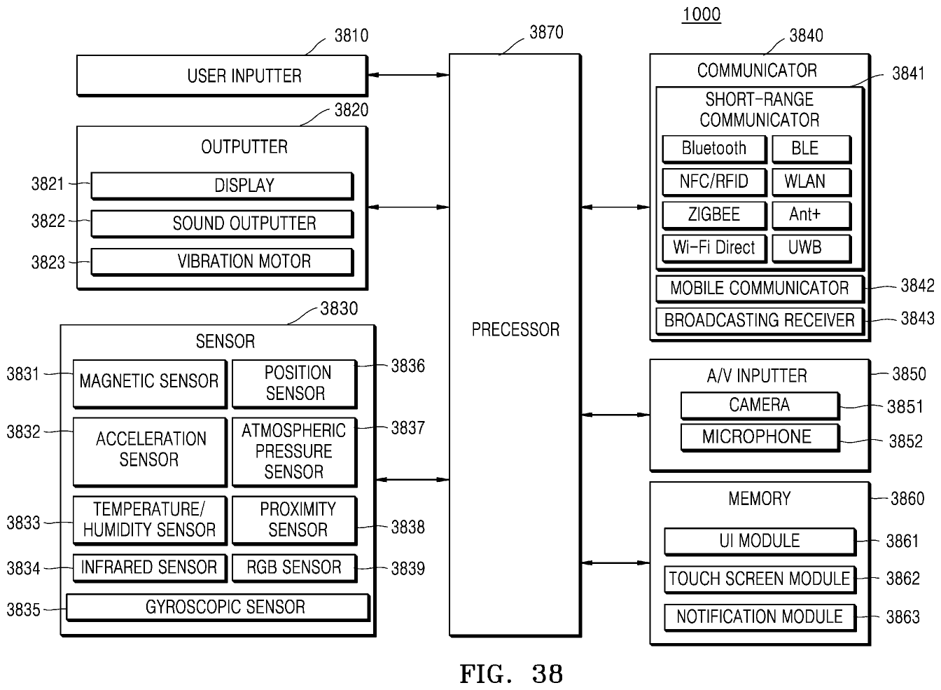

FIG. 37 is a block diagram illustrating an example configuration of an electronic device according to various embodiments.

Referring to FIG. 37, the electronic device 1000 according to an embodiment of the disclosure may include a communicator (e.g., including communication circuitry) 3710, a memory 3720, and a processor (e.g., including processing circuitry) 3730. However, not all of the illustrated components are essential components. That is, the electronic device 1000 may be implemented using more components or fewer components than the components illustrated in FIG. 37.

The communicator 3710 may include various communication circuitry and communicate with an external device. The communicator 3710 may transfer a signal or data received from an external device to the processor 3730 or a signal or data generated in the processor 3730 to an external device. For example, a communication module may be in the form of a chipset or a sticker/barcode including information needed for communication (e.g., a sticker including an NFC tag). According to an embodiment of the disclosure, the communicator 3710 may include a short-range wireless communicator to communicate with the electronic pen 100. The short-range wireless communicator may include an NFC unit, a WLAN (WiFi) communicator, a Zigbee communicator, an IrDA communicator, a WFD communicator, a UWB communicator, an Ant+ communicator, an ultrasound communicator, or the like, but is not limited thereto.

According to an embodiment of the disclosure, the communicator 3710 may communicate with the electronic pen 100. In addition, the communicator 3710 may communicate with a target device which is another external device.

The memory 3720 may store a program for processing or controlling the processor 3730 and store data input to the electronic device 1000 or output from the electronic device 1000. Programs stored in the memory 3720 may be classified into a plurality of modules according to their functions.

The memory 3720 may include at least one type of storage medium selected from a flash memory type storage medium, a hard disk type storage medium, a multimedia card micro type storage medium, a card type memory (e.g., SD or XD memory), a RAM, a SRAM, a ROM, an EEPROM, a PROM, a magnetic memory, a magnetic disc, or an optical disc.

The processor 3730 may include various processing circuitry and controls an overall operation of the electronic device 1000. For example, the electronic device 1000 may control an overall process of executing an operation based on a user input via the electronic pen 100 by executing programs stored in the memory 3720. The processor 3730 may include at least one processor.

According to an embodiment of the disclosure, the processor 3730 may execute a program for executing an operation based on a user input via the electronic pen 100 stored in the memory 3720 to control connection to the electronic pen 100, receive, from the electronic pen 100, a first user input via a touch input to a touch pad or at least one operation from among rotation of at least a part of the electronic pen 100 or the entire electronic pen 100, and execute a preset operation based on the first user input.

According to an embodiment of the disclosure, the processor 3730 may control the electronic device to change a viewpoint of a user on a screen displayed to the user according to a touch input direction with respect to the touch pad or a rotational direction of the at least a part of the electronic pen 100 or the entire electronic pen 100. Also, the processor 3730 may control to change at least a portion of the screen displayed to the user or the entire screen according to a touch input direction with respect to the touch pad or a rotational direction of the at least a part of the electronic pen 100 or the entire electronic pen 100. Furthermore, the processor 3730 may control to increase or reduce a preset value according to a touch input direction with respect to the touch pad or a rotational direction of the at least a part of the electronic pen 100 or the entire electronic pen 100. The processor 3730 may control the amount by which a preset value is increased or decreased to vary according to a touch input speed with respect to the touch pad or a rotational speed of the at least a part of the electronic pen 100 or the entire electronic pen 100.

According to an embodiment of the disclosure, the processor 3730 may determine an orientation of the electronic pen 100, and may control to execute a preset operation according to the orientation of the electronic pen 100. In addition, the processor 3730 may control to receive a second user input to select at least one of an area, field, task, or application to execute a preset operation and execute the preset operation on at least one of the area, field, task, or application selected according to the second user input. Furthermore, the processor 3730 may control to receive a third user input of selecting a point on a screen displayed to a user, and to receive a fourth user input of moving the electronic pen 100 while receiving the third user input, and to move, according to the fourth user input, at least a portion of the screen displayed to the user or the entire screen with respect to that point.

According to an embodiment of the disclosure, the processor 3730 may control the electronic device to receive a fifth user input via movement of the electronic pen 100 and to execute a preset operation based on the fifth user input. The processor 3730 may control to render a two-dimensional image or a three-dimensional image. Also, the processor 3730 may control to measure a movement distance of the electronic pen 100. Furthermore, the processor 3730 may control to receive a fifth user input based on at least one of an orientation, a direction, a movement speed, a movement period of the electronic pen 100 or a number of rotations of a rolling ball tip.

According to an embodiment of the disclosure, the processor 3730 may control the electronic device to receive a sixth user input via the electronic pen 100 and to undo execution of a preset operation based on the sixth user input. Also, the processor 3730 may control to display an image for calibration of the electronic pen 100, receive a seventh user input regarding the image via the electronic pen 100, and transmit a result regarding the seventh user input to the electronic pen 100.

According to an embodiment of the disclosure, the processor 3730 may control the electronic device to select a target device using the electronic pen 100, connect to the target device, and transmit or receive information to or from the target device. The processor 3730 may control to transmit at least one of an infrared signal or an ultrasound signal to the target device using the electronic pen 100. Also, the processor 3730 may control to receive an initial connection message from the target device and execute connection to the target device based on the initial connection message. Also, the processor 3730 may control to connect to the target device through at least one of Bluetooth, WiFi, WFD, NFC, or UWB. Furthermore, the processor 3730 may control to transmit or receive at least one of control information or status information of the target device.

FIG. 38 is a block diagram illustrating an example configuration of an electronic device according to various embodiments.

FIG. 38 is a detailed view of the configuration of the electronic device 1000 illustrated in FIG. 37. A communicator 3840, a memory 3860, and a processor 3870 of FIG. 38 may respectively correspond to the communicator 3710, the memory 3720, and the processor 3730 of FIG. 37.

A user inputter 3810 may refer, for example, to a component including various input circuitry allowing a user to input data for controlling the electronic device 1000. For example, the user inputter 3810 may include a keypad, a dome switch, a touchpad (e.g., a touch capacitive type touch pad, a pressure resistive type touch pad, an infrared beam detecting type touch pad, a surface ultrasonic wave conduction type touch pad, an integral strain gauge type touch pad, a piezo-effect type touch pad, etc.), a jog wheel, a jog switch, and the like, but is not limited thereto.

An outputter 3820 may include various output circuitry and output an audio signal, a video signal or a vibration signal, and the outputter 3820 may include a display 3821, a sound outputter 3822, and a vibration motor 3823.

The display 3821 outputs and displays information processed using the electronic device 1000. When the display 3821 and a touch pad are in a layered structure to form a touch screen, the display 3821 may also be used as an input device as well as an output device. The display 3821 may include, for example, and without limitation, at least one of a liquid crystal display, a thin film transistor-liquid crystal display, an organic light-emitting diode display, a flexible display, a three-dimensional (3D) display, or an electrophorectic display. The electronic device 1000 may include two or more displays 3821 according to an implementation form of the electronic device 1000. Two or more displays 3821 may be arranged to face each other using a hinge.

The sound outputter 3822 may include various sound output circuitry and outputs audio data received from the communicator 3840 or stored in the memory 3860. In addition, the sound outputter 3822 outputs a sound signal related to a function performed in the electronic device 1000 (for example, a call signal receiving sound, a message receiving sound, a notification sound). The sound outputter 3822 may include a speaker, a buzzer, or the like.

A vibration motor 3823 may output a vibration signal. For example, the vibration motor 3823 may output a vibration signal corresponding to output of audio data or video data (for example, a call signal receiving sound, a message receiving sound, or the like). In addition, the vibration motor 3823 may output a vibration signal when a touch is input to a touch screen.

A sensor 3830 may detect a state of the electronic device 1000 or a state of the surroundings of the electronic device 1000 and transfer the detected information to the processor 3870.

The sensor 3830 may include at least one of a geomagnetic sensor 3831, an acceleration sensor 3832, a temperature/humidity sensor 3833, an infrared sensor 3834, a gyroscopic sensor 3835, a position sensor 3836 (for example, a GPS), an atmospheric pressure sensor 3837, a proximity sensor 3838, or an RGB sensor 3839 (illuminance sensor), but is not limited thereto. The functions of the respective sensors may be intuitively inferred from their names by one of ordinary skill in the art, and thus detailed description thereof will be omitted.

The communicator 3840 may include various communication circuitry and communicate with an external device. The communicator 3840 may transfer a signal or data received from an external device to the processor 3870 or a signal or data generated in the processor 3870 to an external device. For example, a communication module may be in the form of a chipset or a sticker/barcode including information needed for communication (e.g., a sticker including an NFC tag). The communicator 3840 may include at least one component that allows communication between the electronic device 1000 and the electronic pen 100 or between the electronic device 1000 and a target device. For example, the communicator 3840 may include a short-range wireless communicator 3841, a mobile communicator 3842, and a broadcasting receiver 3843.

The short-range wireless communicator 3841 may include a Bluetooth communicator, a Bluetooth Low Energy (BLE) communicator, a Near-Field Communication unit, a WLAN (WiFi) communicator, a Zigbee communicator, an IrDA communicator (not shown), a WFD communicator, a UWB communicator, or an Ant+ communicator, but is not limited thereto.

The mobile communicator 3842 may transmit or receive a wireless signal to or from at least one of a base station on a mobile communication network, an external terminal, or a server. A wireless signal may include a voice call signal, a video telephony call signal or various types of data according to transmission or reception of text and multimedia messages.

The broadcasting receiver 3843 receives a broadcasting signal and/or information related to broadcasting from the outside via a broadcasting channel. The broadcasting channel may include a satellite channel or a terrestrial channel. According to an embodiment of the disclosure, the electronic device 1000 may not include the broadcasting receiver 3843.

Also, the communicator 3840 may transmit or receive information needed to execute an operation based on a user input via the electronic pen 100, to or from the electronic pen 100, a target device, or other devices.

An audio/video (NV) inputter 3850 may include various NV input circuitry and is used to input an audio signal or a video signal and may include a camera 3851 and a microphone 3852. The camera 3851 may receive an image frame such as a still image or a moving image using an image sensor in a video call mode or a photographing mode. An image captured using an image sensor may be processed using the processor 3870 or an additional image processor (not shown).

The image frame processed using the camera 3851 may be stored in the memory 3860 or transmitted to the outside via the communicator 3840. Two or more cameras 3851 may be included according to a structural aspect of a terminal.

The microphone 3852 receives an external sound signal and processes the same to electrical voice data. For example, the microphone 3852 may receive a sound signal from an external device or a person who is speaking. The microphone 3852 may use various noise elimination algorithms to eliminate noise generated during reception of an external sound signal.

The memory 3860 may store a program for processing or controlling of the processor 3870 and store data input to the electronic device 1000 or output from the electronic device 1000. Programs stored in the memory 320 may be classified into a plurality of modules according to their functions.

The memory 3860 may include at least one type of storage medium selected from a flash memory type storage medium, a hard disk type storage medium, a multimedia card micro type storage medium, a card type memory (e.g., SD or XD memory), a RAM, an SRAM, a ROM, an EEPROM, a PROM, a magnetic memory, a magnetic disc, or an optical disc.

Programs stored in the memory 3860 may be classified into a plurality of modules according to their functions. For example, the programs may be classified into a user interface (UI) module 3861, a touch screen module 3862, a notification module 3863, or the like.

The UI module 3861 may provide a specialized UI or a specialized graphical user interface (GUI) that are linked to the electronic device 1000 according to applications. The touch screen module 3862 may detect a touch gesture on a touch screen of a user and transfer information about the touch gesture to the processor 3870. The touch screen module 3862 according to an embodiment of the disclosure may recognize and analyze a touch code. The touch screen module 3862 may be configured as an additional hardware component including a controller.

Various sensors may be included inside or near a touch screen to detect a touch or a proximity touch of the touch screen. An example of a sensor for detecting a touch of a touch screen is a tactile sensor. A tactile sensor may refer, for example, to a sensor that detects contact of a certain object to a degree perceivable by a person or greater. A tactile sensor may detect various types of information such as roughness of a contact surface, rigidity of a contact object, a temperature of a point of contact, or the like.

An example of a sensor for detecting a touch of a touch screen is a proximity sensor.

A proximity sensor may refer, for example, to a sensor that detects the presence or absence of an object approaching a certain detection surface or an object present nearby the proximity sensor, using a force of an electromagnetic field or infrared rays, without using a mechanical contact. Examples of the proximity sensor may include a transmissive photoelectric sensor, a direct reflective photoelectric sensor, a mirror reflective photoelectric sensor, a high-frequency oscillation proximity sensor, a capacitive proximity sensor, a magnetic proximity sensor, an infrared proximity sensor, and the like. Examples of a touch gesture of a user may include a tap, a touch & hold, a double tap, a drag, a panning, a flicking, a drag and drop, and a swipe.

The notification module 3863 may generate a signal for notifying the occurrence of an event of the electronic device 1000. Examples of events generated in the electronic device 1000 include a reception of a call signal, a reception of a message, an input of a key signal, a notification of a schedule, or the like. The notification module 3863 may output a notification signal in the form of a video signal via the display 3821, output a notification in the form of an audio signal via the sound outputter 3822, or output a notification signal in the form of a vibration signal via the vibration motor 3823.

The processor 3870 may include various processing circuitry and controls an overall operation of the electronic device 1000. For example, the electronic device 1000 may execute programs stored in the memory 3860 to control the user inputter 3810, the outputter 3820, the sensor 3830, the communicator 3840, the A/V inputter 3850, or the like, to thereby execute an operation based on a user input via an electronic pen. The processor 3870 may include at least one processor.

The disclosed embodiments of the disclosure may be realized by S/W programs including instructions stored in computer-readable storage media.

A computer may refer, for example, to a device capable of calling a stored instruction from a storage medium and operating according to the disclosed embodiments of the disclosure according to the called instruction, and may include a user terminal, a device, a server, and an image processing device according to the embodiments of the disclosure.

The computer-readable storage medium may be provided in the form of a non-transitory storage medium. Here, the ‘non-transitory’ storage medium does not include a signal and is tangible, but does not distinguish whether data is stored in the storage medium semi-permanently or temporarily.

In addition, an electronic device or method according to the embodiments of the disclosure may be provided in a computer program product. The computer program product may be traded between a seller and a buyer as a product.

The computer program product may include an S/W program and a computer-readable storage medium storing the S/W program. For example, the computer program product may include a product (e.g., a downloadable app) in the form of an S/W program distributed electronically through a manufacturer of an electronic device or an electronic market (e.g., Google Play™ store, App Store). For electronic distribution, at least a part of an S/W program may be stored in a storage medium or temporarily generated. In this case, the storage medium may be a server of a manufacturer, a server of an electronic market, or a storage medium of a relay server that temporarily stores a SW program.

The computer program product may include a storage medium of a server or a storage medium of a terminal in a system including a server and a terminal (for example, an image transmitting device or an image receiving device). Alternatively, when there is a third device (e.g., a smartphone) that is connected to the server or the terminal via communication, the computer program product may include a storage medium of the third device. The computer program product may include an S/W program itself transmitted from the server to the terminal or the third device or transmitted from the third device to the terminal.

In this case, one of the server, the terminal, and the third device may execute the computer program product to perform the method according to the embodiments of the disclosure. Alternatively, two or more of the server, the terminal, and the third device may execute the computer program product to execute the method according to the disclosed embodiments in a distributed manner.

For example, a server (for example, a cloud server or an artificial intelligence server, etc.) may execute a computer program product stored in the server to control a terminal connected to the server via communication to perform the method according to the embodiments of the disclosure.

As another example, the third device may execute a computer program product to control a terminal connected to the third device via communication to perform the method according to the embodiments of the disclosure. As a specific example, the third device may control to transmit or receive a packing image by remotely controlling an image transmitting device or an image receiving device.

When the third device executes a computer program product, the third device may download the computer program product from the server and execute the downloaded computer program product. The third device may execute a computer program product provided in a preloaded state to perform the method according to the embodiments of the disclosure.

An embodiment of the disclosure may also be realized in the form of a recording medium including instructions executable by a computer, such as a program module executed by a computer. A computer-readable recording medium may be an arbitrary available medium accessible by a computer, and may be any one of volatile, nonvolatile, separable, and non-separable media. Examples of the computer-readable recording medium may include a computer storage medium and a communication medium. Examples of the computer storage medium include volatile, nonvolatile, separable, and non-separable media realized by an arbitrary method or technology for storing information about a computer-readable instruction, a data structure, a program module, or other data. A communication medium typically includes computer readable instructions, data structures, program modules, or other data in a modulated data signal such as a carrier wave, or other transmission mechanism, and includes any information transfer medium.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents.

What is claimed is:

1. A method of operating an electronic device that executes an operation based on a user input via an electronic pen, the method comprising:
connecting to the electronic pen;
receiving, from the electronic pen, a first input via a touch input to a touch pad or at least one operation of rotation of at least a part of the electronic pen or the entire electronic pen; and
executing a preset operation based on the first input.

2. The method of claim 1, wherein the executing of the preset operation comprises changing a viewpoint of a user on a screen displayed to the user based on a touch input direction with respect to the touch pad or a rotational direction of the rotation of the at least a part of the electronic pen or the entire electronic pen.

3. The method of claim 1, wherein the executing of the preset operation comprises changing at least a portion of a screen displayed to a user or the entire screen based on a touch input direction with respect to the touch pad or a rotational direction of the rotation of the at least a part of the electronic pen or the entire electronic pen.

4. The method of claim 1, wherein the executing of the preset operation comprises increasing or reducing a preset value based on a touch input direction with respect to the touch pad or a rotational direction of the rotation of the at least a part of the electronic pen or the entire electronic pen.

5. The method of claim 4, wherein the amount by which a preset value increases or decreases varies based on a touch input speed with respect to the touch pad or a rotational speed of the rotation of the at least a part of the electronic pen or the entire electronic pen.

6. The method of claim 1, wherein the executing of the preset operation comprises:
determining an orientation of the electronic pen; and
executing the preset operation based on the orientation of the electronic pen.

7. The method of claim 1, further comprising receiving a second input for selecting at least one of an area, field, task, or application to execute the preset operation,
wherein the executing of the preset operation comprises executing the preset operation with respect to at least one of the area, field, task, or application selected based on the second input.

8. The method of claim 1, further comprising:
receiving a third input of selecting a point on a screen displayed to a user; and
receiving, while receiving the third input, a fourth input of moving the electronic pen,
wherein the executing of the preset operation comprises moving, based on the fourth input, at least a portion of a screen displayed to the user or the entire screen with respect to the point.

9. The method of claim 1, further comprising:
receiving a fifth input via movement of the electronic pen; and
executing a preset operation based on the fifth input.

10. The method of claim 1, further comprising:
selecting a target device via the electronic pen;
connecting to the target device; and
transmitting or receiving information to or from the target device.

11. An electronic device configured to execute an operation based on an input via an electronic pen, the electronic device comprising:
a communicator comprising circuitry configured to communicate with the electronic pen;
at least one memory storing a program for executing an operation based on an input via the electronic pen; and
at least one processor configured to execute the program to control the electronic device to: connect to the electronic pen, receive a first input via a touch input to a touch pad or at least one operation of a rotation of at least a part of the electronic pen or the entire electronic pen, and execute a preset operation based on the first input.

12. The electronic device of claim 11, wherein the at least one processor is further configured to control the electronic device to change a viewpoint of a user on a screen displayed to the user based on a touch input direction with respect to the touch pad or a rotational direction of the rotation of the at least a part of the electronic pen or the entire electronic pen.

13. The electronic device of claim 11, wherein the at least one processor is further configured to control the electronic device to change at least a portion of a screen displayed to a user or the entire screen based on a touch input direction with respect to the touch pad or a rotational direction of the rotation of the at least a part of the electronic pen or the entire electronic pen.

14. The electronic device of claim 11, wherein the at least one processor is further configured to control the electronic device to receive a fifth input via movement of the electronic pen, and execute a preset operation based on the fifth input.

15. The electronic device of claim 11, wherein the at least one processor is further configured to control the electronic device to select a target device via the electronic pen, connect to the target device, and transmit or receive information to or from the target device.
